(19) United States
(12) Patent Application Publication
(10) Pub. No.: US 2002/0065853 A1
(43) Pub. Date: May 30, 2002

(54) Electronic document management for updating source file based upon edits on print-outs

(76) Inventors: Sadao Takahashi, Yokohama (JP); Hitoshi Hattori, Yokosuka-shi (JP); Taiga Asano, Ebina-shi (JP); Nobuyuki Doi, Tokyo (JP); Toshiyuki Furuta, Kawasaki-shi (JP); Tomohiko Beppu, Kawasaki-shi (JP); Makoto Yamasaki, Tokyo (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 09/948,956

(22) Filed: Sep. 7, 2001

(30) Foreign Application Priority Data
Aug. 9, 2000 (JP) 2000-272576
Mar. 8, 2001 (JP) 2001-236848

(51) Int. Cl. G06F 15/00

(52) U.S. Cl. 707/527; 707/541

(57) ABSTRACT

One aspect of the current invention is related to updating an electronic source file based upon the edits made on a recording medium such as a print out. In other words, after the content of the source file is printed on a sheet of paper, when any edit is made to the printed sheet, the edit is automatically incorporated into the original source file without any human intervention to identify the edit or the original source file.

### FIELD OF THE INVENTION

The current invention is generally related to a document management system, method and software as well as a recording medium to be used, and more particularly related to an aspect of updating an electronic source file based upon the edits made on a recording medium such as a print out.

### BACKGROUND OF THE INVENTION

Digitized documents are generally displayed on a display monitor. The display mode faces difficulty in readability and portability. For these reasons, the digitized documents are often printed out for readability and portability. Furthermore, people write on the print outs, and the added information on the print out is not linked with the original digital data. This requires an additional editing of the original digital file based upon the edited print out. To eliminate the after-the-fact editing session, it is highly desirable to have a print out that can be edited and to automatically incorporate the edit into the digital file. In other words, it is highly desirable to have a paper-based edit and display system.

To accomplish the above described system, it is necessary to obtain the coordinates on the paper. In this regard, Japanese Patent Laid Publication Hei 9-101864 discloses a paper-based information display/storage medium for editing the information. A single information recording device is used to input hand-written information, and the information is stored in a plurality of the information display/storage media. Subsequently, the information recording device reads the stored information from one of the information display/storage media and displays the retrieved information on a display unit. The information display/storage media allow the user to edit or delete the stored information and ultimately to implement paper-less documents.

Japanese Patent Laid Publication Hei 61-296421 and 7-141104 disclose a technique to obtain coordinate information based upon optically readable code symbols that are placed in a matrix fashion. Furthermore, Japanese Patent Laid Publication Hei 7-244657 discloses a technique to edit information in a particular file whose file name is read from a bar code that is placed on a paper output.

Despite the above described advantages in the prior art technologies, there are still some short comings. Japanese Patent Laid Publication Hei 9-101864 has proposed the best of the worlds of a paper-based memory means and a computer-based memory means for displaying information such as characters and images. Unlike paper, the memory medium allows the user to add and erase the computer generated and the hand-written information without expending any resource such as paper.- The information is easily inputted to, stored in and outputted from a computer file. On the other hand, since a plurality of the display/storage media or print outs have to be placed on a tablet in order to write for inputting additional information, it is still inconvenient that the user has to carry both the display/storage media and the tablet. For personal use, it is necessary to have convenience and function that is equivalent of the traditional use of paper. The use of the tablet unfortunately leads to unfamiliar sensation that is different from sensation gained from paper and a pen. The above inconvenience is common to the technologies that are disclosed by Japanese Patent Laid Publications 61-296421 and 7-141104. For the technique disclosed by Japanese Patent Laid Publication Hei 7-244657, it is inconvenient to read a bar code that is placed on a paper output before each editing session.

Japanese Laid Patent Publication Hei 11-368805, filed on Dec. 27, 1999 discloses a system for determining pen coordinates in real time by optically reading code symbols that are placed on a sheet of print out via a miniature camera placed on the pen while the user is editing the print out. Based upon the pen coordinates, the edited information is incorporated into the digital file.

As described above, it is desirable to have a system for automatically incorporating any edit on a print out into a corresponding digital document without human intervention. Since the print out is a copy of the original, it is necessary to identify the original digital document file based upon the copy in order to maintain the consistency between the copy and the digital file. When a code symbol on a print out is destroyed or not identifiable, it becomes impossible to obtain the identification information from the code symbol. This causes the failure in maintaining the identical information between the print out and the digital document.

It is also highly desirable to have a system without the use of the prior art tablet for automatically and simultaneously incorporating any edit on a plurality of print outs into a corresponding digital document without human intervention. Print outs are used in environment such as offices, conferences for reviewing documents, and creative activities.

### SUMMARY OF THE INVENTION

In order to solve the above and other problems, according to a first aspect of the current invention, a method of managing a document, including: printing the document from an electronic source file on a recording medium with a predetermined set of encoded information at least on coordinates and a file identification of the electronic source file; diting the document on the recording medium to generate modification; reading the modification and the encoded information from the recording medium simultaneously with the editing; decoding the encoded information to generate the coordinates and the file identification; and updating the electronic source file based upon the file identification, the modification and the coordinates.

According to a second aspect of the current invention, a computer readable medium storing a computer program for managing a document, the computer program causing a computer and an associated peripheral device to perform the following tasks: printing the document from an electronic source file on a recording medium with a predetermined set of encoded information at least on coordinates and a file identification of the electronic source file; editing the document on the recording medium to generate modification; reading the modification and the encoded information from the recording medium simultaneously with the editing; decoding the encoded information to generate the coordinates and the file identification; and updating the electronic source file based upon the file identification, the modification and the coordinates.

According to a third aspect of the current invention, a system for managing a document, including: a storage unit for storing an electronic source file containing the document; a printer connected to the storage unit for printing the document from the electronic source file on a recording medium with a predetermined set of encoded information at least on coordinates and a file identification of the electronic source file; a writing instrument for editing the document on the recording medium to generate modification, the writing instrument including a reading unit for simultaneously reading the modification and the encoded information from the recording medium while editing the document; and an information processing unit operationally connected to the writing instrument and the storage unit for decoding the encoded information to generate the coordinates and the file identification, the information processing unit updating the electronic source file based upon the file identification, the modification and the coordinates.

According to a fourth aspect of the current invention, a recording medium to be used in a document management system, including: a recording area for printing the document in a visible form, the recording area being further recording additional information; and a predetermined set of encoded information at least on coordinates and a file identification of the electronic source file, the encoded information being subsequently decoded to determine the coordinates on the recording area and the electronic source file, the additional information being combined with the coordinates and the file identification for use in updating the electronic source file according to the additional information.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is one example of a recording medium or an image-information carrying medium to be used with the current invention.

FIG. 2 is a block diagram illustrating one preferred embodiment, a document management system according to the current invention.

FIG. 3 is a diagram illustrating certain components of an electrophotography recording type printer.

FIG. 4 is a diagram illustrating certain components of a digital copier having a scanner unit.

FIG. 5 is a diagram illustrating how the code reading units read the code symbol according to the current invention.

FIG. 6 is a table illustrating the data structure for a mapping file stored in the HDD 212 of the information processing unit.

FIG. 7 illustrates that the copier duplicates the recording medium including not only the image but also the code symbols in an exemplary duplicating process.

FIG. 8 is a diagram illustrating one preferred embodiment of the recording medium according to the current invention.

FIG. 9 is a block diagram illustrating one preferred embodiment of the coordinate input unit according to the current invention.

FIG. 10 is a diagram illustrating one example of an image on the recording medium.

FIG. 11 illustrates one example of the special pattern area.

FIG. 12 illustrates that the code symbol is decoded to obtain the coordinate information when a two dimensional code is decoded from an image.

FIG. 13 shows a positional relationship between an image and a code symbol.

FIG. 14 illustrates another example of the image.

FIG. 15 is a figure for the image in the second example that correspond to FIG. 13.

FIG. 16 shows that the code symbol is indicated only by an outside frame.

FIG. 17 is a diagram illustrating one preferred embodiment of an erasable or reusable recording medium according to the current invention.

FIG. 18 shows that a lower layer is provided for shielding heat between the support layer and the recording layer in order to use heat in an efficient manner.

FIG. 19 is a graph illustrating that the recording layer containing the leuco dyne and the developer, colors and discolors according to the predetermined processes.

FIG. 20 is a graph illustrating a process in which the recording layer having organic low molecules and resin changes its color from transparency to white depending upon the temperature.

FIG. 22 is a perspective view illustrating that a user holds the writing instrument and writes over the recording medium

FIG. 23 is a diagram illustrating an exemplary image that is read from the recording medium as shown in FIG. 21 by the coordinate input unit.

FIG. 24 is a flow chart illustrating steps involved in determining the coordinates of tip on the recording medium by the microprocessor based upon the encoded data from the scanned image of the code symbol according to the current invention.

FIG. 25 is a diagram illustrating a partial image from the recording medium that is read by the image-reading unit to show another exemplary detection of the coordinates on the recording medium.

FIG. 26 is a flow chart illustrating steps involved in determining the coordinates of tip on the recording medium by the microprocessor based upon the encoded data from the scanned image of the code symbol and the additional symbols according to the current invention.

FIG. 27 illustrates that at least four of the two-dimensional code symbols are scanned.

FIG. 28 is a flow chart illustrating steps involved in determining the coordinates of tip on the recording medium by the microprocessor based upon the encoded data from the scanned image of the four code symbols according to the current invention.

FIG. 29 is a diagram illustrating a partial image from the recording medium that is read by the image-reading unit to show another exemplary detection of the coordinates on the recording medium.

FIG. 30 shows an exemplary code symbol that is assumed to have encoded “0102” and be read from the code symbol, which is located at the upper left corner of the recording medium.

FIG. 31 shows that the information processing unit converts the code symbol into a corresponding code symbol of another code group.

FIG. 32 is a diagram illustrating exemplary coordinates of the code symbol.

FIG. 33 illustrates the converted code symbol along with other code symbols on the recording medium.

FIG. 34 is a block diagram illustrating one preferred embodiment of the information processing unit, the printer or the copier according to the current invention.

FIG. 35 is a block diagram illustrating an alternative embodiment of the information processing unit, the printer or the copier according to the current invention.

FIG. 36 shows an exemplary mapping record in the second code coordinate mapping document storage unit.

FIG. 37 is a diagram illustrating first code symbols and second code symbols printed on a recording medium according to the current invention.

FIG. 38 is a diagram illustrating the two types of code symbols are superimposed.

FIGS. 39(a), 39(b) and 39(c) are diagrams illustrating one preferred method of improving the coordinate reading precision according to the current invention.

FIG. 40 is a block diagram illustrating a preferred embodiment of the information processing unit, the printer or the copier according to the current invention.

### DETAILED DESCRIPTION OF THE PREFERRED EMBODIMENT(S)

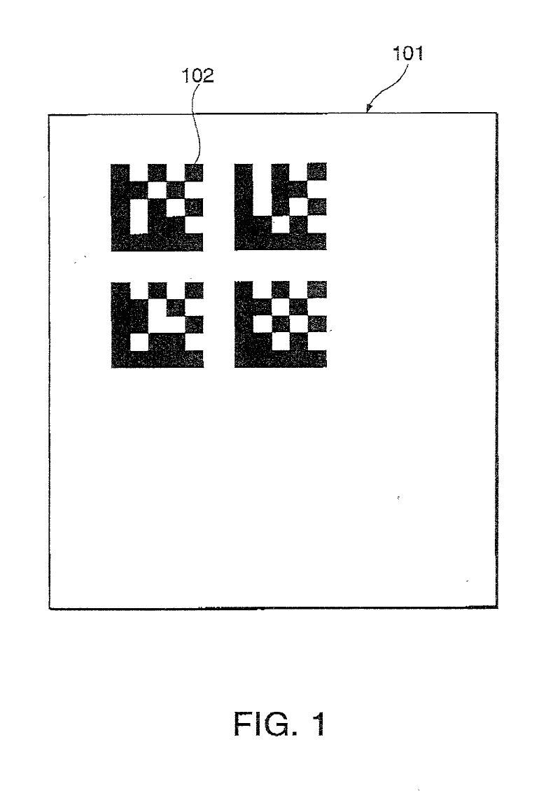

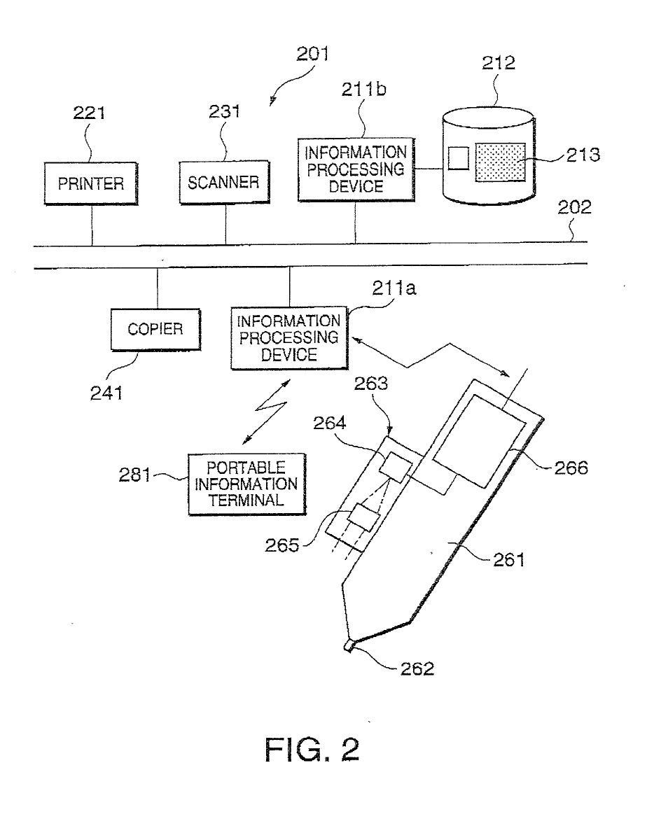

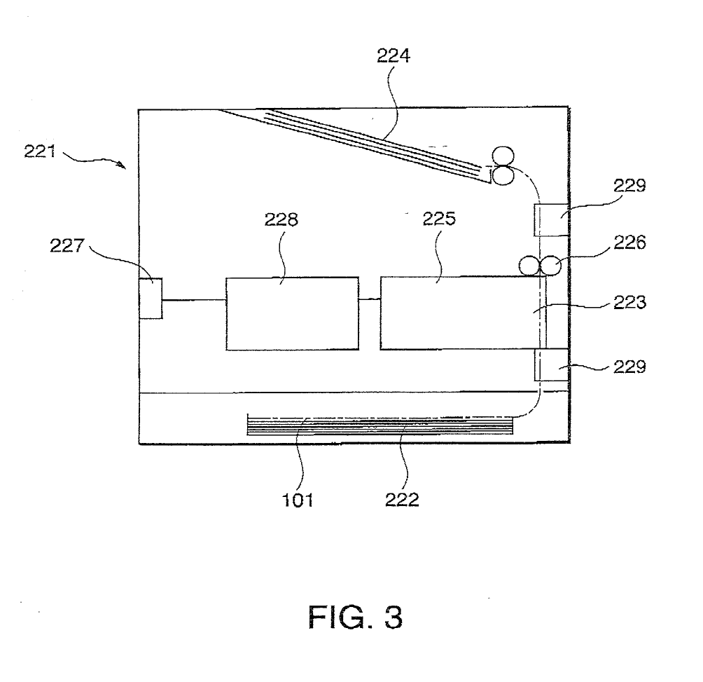

Referring now to the drawings, wherein like reference numerals designate corresponding structures throughout the views, and referring in particular to FIG. 1, one example of a recording medium or an image-information carrying medium 101 to be used with the current invention. The recording medium 101 is a sheet made of certain materials such as paper, cloth and plastic for recording information to be perceived by a human. The information is recorded on the recording medium 101 manually by a user as will be shown in FIG. 2 using a writing instrument 261 or by an image-forming device such as a copier and a printer as shown in FIGS. 2 and 3 using a copier 241. The recording medium 101 further includes predetermined optically readable code symbol 102 on its surface. Examples of the code symbol 102 include two dimensional bar codes such as bar codes.

Although only four of the code symbols 102 are shown in FIG. 1, a plurality of code symbols 102 are placed in a matrix on other examples of the recording medium 101. For the purpose of demonstration, the proportion of the code symbols 102 with respect to the recording medium 101 is relatively large in FIG. 1, but the actual size of the code symbols 102 for use with the current invention is much smaller with respect to the recording medium 101. The code symbol 102 contains information on the coordinates. In other words, each of the code symbols 102 contains the X-Y coordinate information on a respective position within the recording medium 101. The code symbol 102 further contains identical information about the recording medium 101 to indicate that every code symbol 102 belongs to the same recording medium 101.

Referring to FIG. 2, a block diagram illustrates one preferred embodiment, a document management system 201 according to the current invention. The document management system 201 includes a predetermined number of information processing units 211a and 211b and peripheral devices such as a printer 221, a scanner 231 and an image duplicating unit 241 over a network 202. The information processing unit 211 is a general microcomputer having a microprocessor and a memory for executing various processes. One of the information processing units 211a receives input data from a writing instrument 261 via wireless communication. The information processing unit 211a also wirelessly communicates with a portable information terminal 281 for data transmission. Another one of information processing unit 211b stores various information on a hard disk (HDD) 212. For example, after information is recorded on the recording medium 101 by devices such as the printer 221 or the copier 241, the information in a mapping file 213 corresponds to image source specifying information for specifying an image source and an information recording medium 101 for recording image data generated based upon the image source specifying information.

The writing instrument 261 includes a writing unit 262 at the tip, which has a mechanism to leave visual trace as a fountain pen, a ball point pen or a mechanical pencil does. Alternatively, the writing unit 262 simply contacts the recording medium 101. If the visual trace is required, the writing instrument 261 includes the above described writing unit 262 for leaving the visual trace. The writing instrument 261 further includes a second code reading unit 263 for optically reading the code symbol 102 as the writing instrument 261 changes its position to write on the recording medium 101. The second code reading unit 263 recognizes the code symbol 102 includes a photoelectric conversion element 264 for receiving light reflected by the code symbol 102 via an optical system 265 and generating an output signal that corresponds to an optical reflection rate of the code symbol 102. The writing instrument 261 also further includes an information processing unit 266 that has a microprocessor and a memory. The information processing unit 266 decodes the code symbol 102 that was read by the second code reading unit 263 and converts image data to coded code data based upon the optical reflection rate. For this reason, the information processing unit 266 includes a file that maps the code and the shape characteristics of the code symbol 102. Lastly, the information processing unit 266 is equipped with a wireless output circuit for transmitting the above described coded data to one of the information processing unit 211a. The code symbol 102 contains information that is equivalent to the coordinate information, and the information processing unit 266 decodes the code symbol 102 to obtain the equivalent coordinate information. In this regard, the information processing unit 266 functions as a second decoding means to decode the code symbol 102 for obtaining the equivalent information. In the preferred embodiment, the information processing unit 266 in the writing instrument 261 transmits the decoded data of the code symbol 102 via wireless communication to the information processing unit 21 la. Alternatively, in another preferred embodiment, the information processing unit 266 in the writing instrument 261 transmits the decoded data of the code symbol 102 via wire communication to the information processing unit 21 la.

In the alternative embodiment, it is necessary for the information processing unit 266 to have a communication interface such as a serial interface. Although in the preferred embodiment, the information processing unit 266 in the writing instrument 261 has the function of the second decoding means, the information processing unit 211, the printer 221 or the copier 241 alternatively has the same function of the decoding means. In other words, any part of the document management system has the decoding finction.

Now referring to FIG. 3, a diagram illustrates certain components of an electrophotography recording type printer 221. A recording medium 101 stored in a paper supply unit 222 is transferred to a paper output unit 224 via a guiding path 223. On the way to the paper output unit 224, the image forming process unit 225 forms an image on the recording medium 101 by toner, and a fixation unit 226 fixes the toner image on the recording medium 101 by pressure and temperature. The printer 221 further includes an image processing unit 228 with a microprocessor and a memory as well as a network interface unit 227 for interfacing with a network 202 to receive image data from the image processing unit 211 as shown in FIG. 2. According to the received image data, the image processing unit 228 controls the image forming process unit 225 to from a toner image on the recording medium 101. The printer 221 also further includes a code reading unit 229 for optically reading code symbol 102 on the recording medium 101, and the code reading unit 229 is located along the guiding path 223. The code reading unit 229 includes similar components that have been described with respect to the previously described second code reading unit 263 in the writing instrument 261. The image processing unit 228 decodes the code symbol 102 that the code reading unit 229 has read and converts to the coded image data based upon the reflection rate. For this reason, the image processing unit 228 has a file that maps the shape characteristics of the code symbol 102 to a corresponding code. The code symbol 102 contains information that is equivalent to the coordinate information, and the information processing unit 228 of the printer 221 decodes the code symbol 102 to obtain the equivalent coordinate information. In this regard, the information processing unit 228 functions as a decoding means to decode the code symbol 102 for obtaining the equivalent information. Although the information processing unit 228 of the printer 221 has the decoding means in this preferred embodiment, the information processing unit 211 alternatively has the decoding function in another embodiment. That is, any part of the document management system optionally has the decoding function. Furthermore, although the preferred embodiment is implemented with a electrophotograpic type printer, other types such as thermal printing and ink jet printing are optionally utilized in other embodiments.

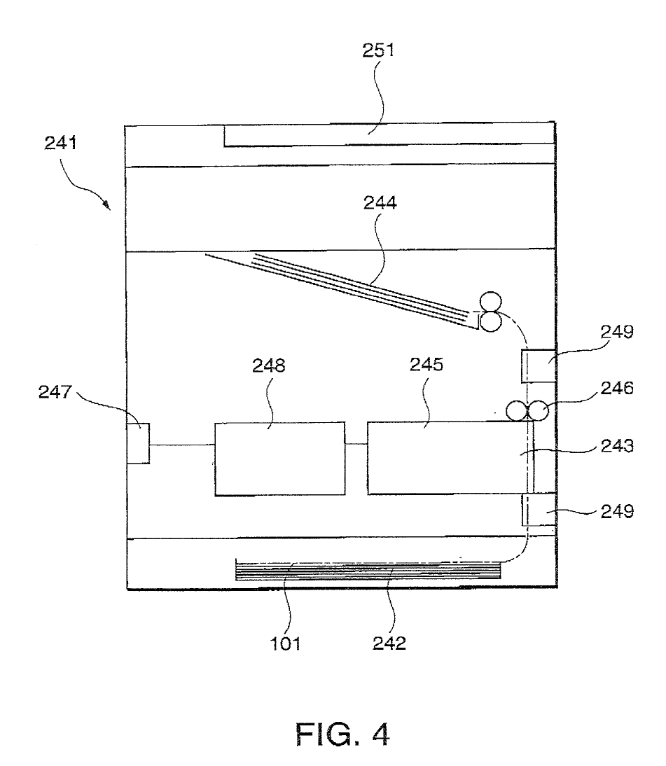

Now referring to FIG. 4, a diagram illustrates certain components of a digital copier 241 having a scanner unit 251. According to the image data scanned by the scanner unit 251, an image processing unit 248 controls the image forming processing unit 245 and forms an toner image on the recording medium 101. The image processing unit 248 further includes a microprocessor and a memory unit. Other components in the digital copier are substantially identical to those of FIG. 3. A printer unit of the digital copier 241 is an electrophographic type image forming device. A recording medium 101 stored in a paper supply unit 222 is transferred to a paper output unit 244 via a guiding path 433. On the way to the paper output unit 244, the image forming process unit 245 forms an image on the recording medium 101 by toner, and a fixation unit 246 fixes the toner image on the recording medium 101 by pressure and temperature. The digital copier 241 further includes an image processing unit 245 with a microprocessor and a memory as well as a network interface unit 247 for interfacing with a network 202 to receive image data from the image processing unit 211 as shown in FIG. 2. According to the received image data, the image processing unit 248 controls the image forming process unit 245 to from a toner image on the recording medium 101. The digital copier 241 also further includes a code reading unit 249 for optically reading code symbol 102 on the recording medium 101, and the code reading unit 229 is located along the guiding path 223. The code reading unit 249 includes similar components that have been described with respect to the previously described second code reading unit 263 in the writing instrument 261 or the printer 221.

The image processing unit 248 decodes the code symbol 102 that the code reading unit 249 has read and converts to the coded image data based upon the reflection rate. For this reason, the image processing unit 248 has a file that maps the shape characteristics of the code symbol 102 to a corresponding code. The code symbol 102 contains information that is equivalent to the coordinate information, and the information processing unit 248 of the digital copier 241 decodes the code symbol 102 to obtain the equivalent coordinate information. Although the information processing unit 248 has the decoding means in this preferred embodiment, the information processing unit 211 alternatively has the decoding function in another embodiment. That is, any part of the document management system optionally has the decoding function.

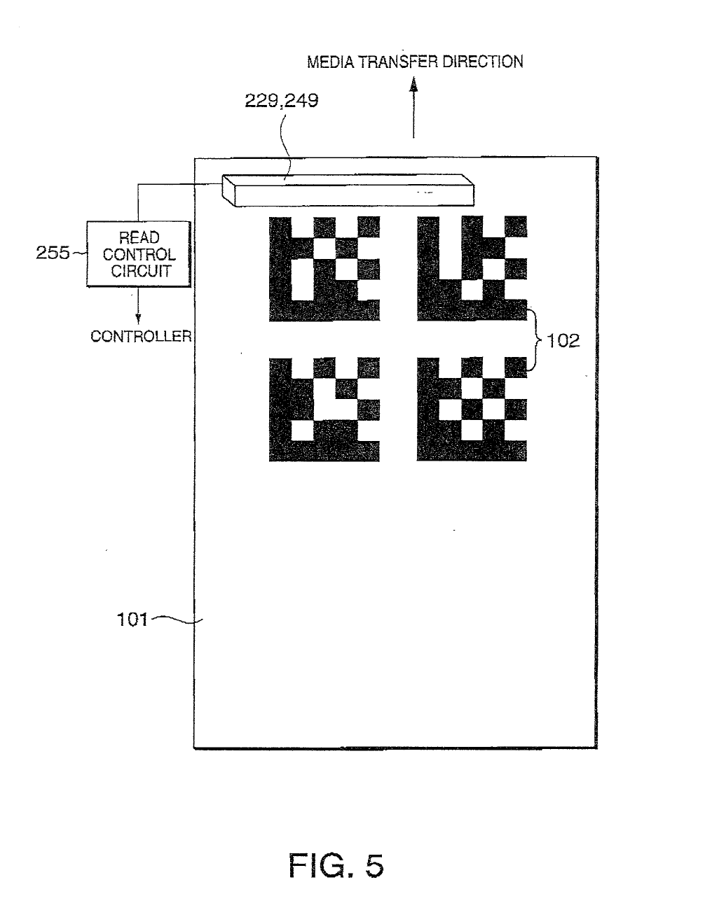

Now referring to FIG. 5, a diagram illustrates how the code reading units 229 and 249 read the code symbol 102 according to the current invention. The code reading units 229 and 249 includes opto-electrical conversion element and scans the recording medium 101. The code reading units 229 and 249 output an output signal based upon the scanned information on the code symbol 102 to the controller or information processing unit 228, 248 via a control circuit 255.

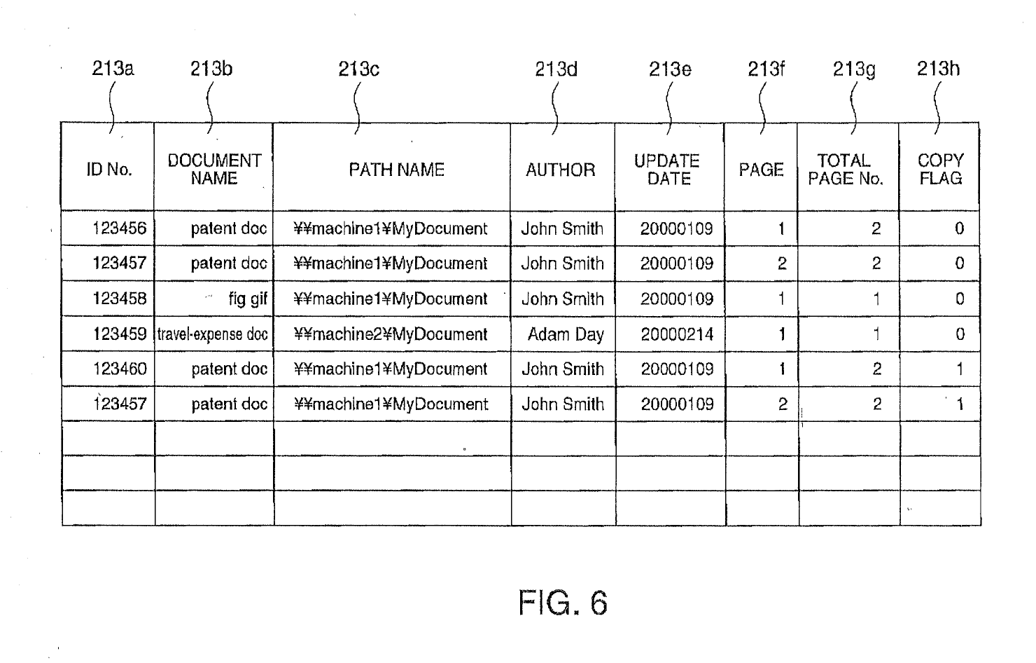

Now referring to FIG. 6, a table illustrates the data structure for a mapping file stored in the HDD 212 of the information processing unit 21 lb. The information in a mapping file 213 corresponds image source specifying information for specifying an image source and an information recording medium 101 for recording image data generated based upon the image source specifying information. In further detail, the equivalent information or recording medium identification contained in the code symbol 102 that the code reading units 229 and 249 of the printer 221 or the copier 241 have read from the recording medium 101 is stored in an identification number 213a as identification information for the recording medium 101. Furthermore, other parts of the mapping file 213 store image source specifying information for specifying an image source that is basic data for an image that is formed by the printer 221 and the copier 241 on the recording medium 101.

For example, the image source means a file that is generated by a word processor application or a financial application after the printer 221 generates image data. The image source specifying information is a path name to specify the image source. In the case of the mapping file 213, a title of the image source is recorded in the title name 213 b while a path name to access the image source is recorded in the path name 213 c. These information is corresponded to the identification information 213a to identify the recording medium 101. In addition, the mapping file 213 stores an author name 213d of the image source, updated time stamp 213e, a page 213f, a total number of pages 213g and a copy flag 213h. Again, these information correspond to the identification information 213a to identify the recording medium 101. The mapping file 213 having the above data structures is stored in the information processing unit 211b having the HDD 212 or alternatively in another information processing unit 211a, the printer 211 or the copier 214.

In one preferred embodiment of the document management system according to the current invention, the information processing unit 211 outputs an image formation command to the printer 221 or the copier 241 for the image data formed from a predetermined image source. According to the received image data, the printer 221 or the copier 241 forms an image on the recording medium 101. During this formation process, the code reading units 229 and 249 read the code symbol 102 placed on the recording medium 101, and the information processing units 228 and 248 decode the code symbol 102 to obtain the equivalent information of the recording medium 101. The information processing units 228 and 248 of the printer 221 and the copier 241 correspond the image source specifying information in the image formation command to the equivalent information of the recording medium 101 and output an output signal indicative of the correspondence to the information processing unit 211b having the mapping file 213 via the network 202. Upon receiving the above correspondence information, the information processing unit 211b stores the correspondence information in the mapping file 213 in the HDD 212. The equivalent information of the recording medium 101 is stored in the identification number 213a of the mapping file 213. Since the image source information that corresponds to the equivalent information includes an author name 213d of the image source, updated time stamp 213e, a page 213f, a total number of pages 213g and a copy flag 213h, these information is stored in the corresponding entry. For the updated time stamp 213e in the mapping file 213, the update time is obtained from the clock function of the information processing unit 211b, and the obtained time is recorded.

In the preferred embodiment, the writing instrument 261 enables to add information on the recording medium 101 that includes the image data formed from the image source. When information is added by the writing instrument 261, the preferred embodiment also enable the addition of the corresponding written data to the image source. That is, when a writing operation takes place using the writing instrument 261 against the recording medium 101 which already contains the formed image, the second code reading unit 263 of the writing instrument 261 reads the code symbols 102, and the information processing unit 266 decodes the image data of the retrieved code symbol 102 to obtain the coordinate information as well as the equivalent information. The writing instrument 261 transmits an output signal indicative of the decoded data to the information processing unit 211 via wireless communication. Based upon the received coordinate information in the code symbol 102, the information processing unit 211a confirms the writing trace of the writing instrument 261. Furthermore, based upon the received equivalent information in the code symbol 102, the information processing unit 211a searches the identification information column 213 a of the mapping file 213 that is stored in the HDD 212 of the other information processing unit 211b in order to obtain a path name 213c that corresponds to image source specifying information. Using the path name 213c, the information processing unit 211a accesses the corresponding image source to open the image source file. Generally, the image source file is opened by an application program that has originally generated the image source file. Having access to the open image source file, the information processing unit 21 la performs a process of adding the pen trace data indicative of the writing trace caused by the movement of the above identified writing instrument 261 on the recording medium 101. In this process, one preferred embodiment of the information processing unit 211a treats the additional writing trace data as image data. Optionally, the information processing unit 211a also treats the additional writing trace data as character code information after recognizing the writing trace data as certain characters. After the above described writing trace data has been added to the image source file, the image source file is updated for storage in the information processing unit 211a or 211b. Alternatively, the image source file is updated for storage in an information memory area of an information processing unit that is not indicated in FIG. 2.

As described above, preferred embodiments of the document management system according to the current invention enable a user to add information by using the writing instrument 261 on the recording medium 101 which contains image data based upon an image source and to update the image source by adding the corresponding added information. When recording media in the paper supply unit 222 and 242 do not contain the code symbol 102, the printer 221 and the copier 241 cannot obtain the equivalent information contained in the code symbol 102 at the time of image formation. In the above described case, the preferred embodiments of the printer 221 and the copier 241 according to the current invention prohibit the image formation via the image forming process units 225 and 245 and report the situation. This detection mechanism prohibits a situation where the recording medium 101 and the image source specifying information cannot be matched and also prevents the waste of the recording medium 101. By providing the above report to the user, a reason for not generating an image is clearly indicated as a failure in corresponding an image source specifying information and distinguishes other reasons such as malfunction of the image forming device in order to avoid confusion.

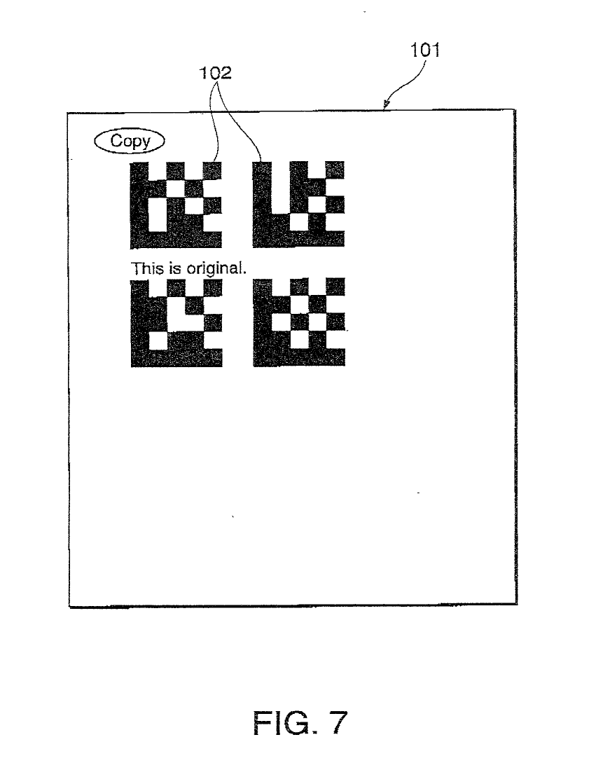

Preferred embodiments of the document management system according to the current invention also enable the user to duplicate via the copier 241 the recording image 101 containing the image based upon the image data in the image source. In the duplication process, the copier 241 duplicates the recording medium 101 including not only the image but also the code symbols as shown in an exemplary copy in FIG. 7. The image processing unit 248 of the copier 241 performs a process to indicate on the recording medium whether the recording medium is a copy or an original. The indication, “Copy” or “Original” is with respect to an image by the image source and is superimposed on the duplicated image.

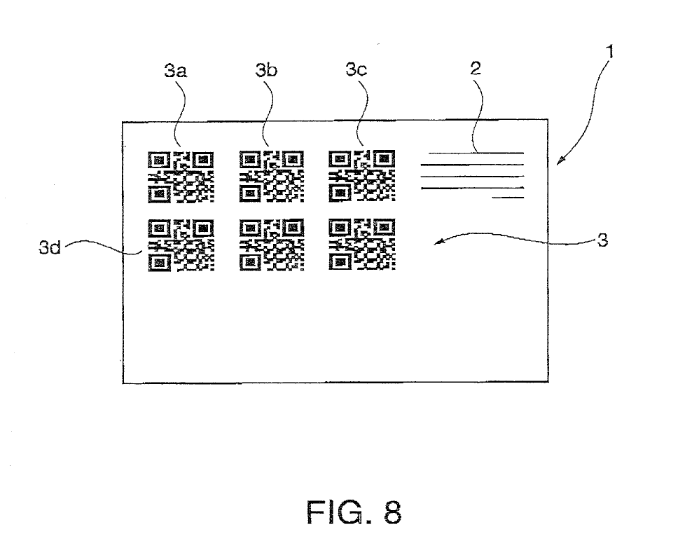

Referring to FIG. 8, a diagram illustrates one preferred embodiment of the recording medium according to the current invention. The recording medium 1 records visually perceptible information by human and is generally a sheet made of paper, cloth, plastic and so on. An area 2 in the recording medium 1 contains a document portion that is hand written and visual to human. The document portion 2 contains characters, diagrams and tables. The recording medium 1 also contains optically recognizable code symbols 3 or 3a through 3d. In general, the code symbol 3 is either a bar code or a dimensional code. By differentiating the light absorption or reflection wavelength of the document portion 2 and the code symbol 3, a human can perceive the document portion 2 while one cannot see the code symbol 3. By printing with an optically recognizable wavelength range, the code symbol 3 is superimposed on the document portion 2. The code symbol is thus independently recognized from the document portion 2. As one example of the humanly imperceptible ink, HitachMaxel offers stealth ink, and thermal transfer sheets are also offered for this ink. The stealth ink is hardly perceptible to human while it is optically recognized under infrared light. On the other hand, another example is that black ink under normal light turns transparent under infrared light. Bu using the above described special types of ink in combination with a thermal printer, a visible document portion 2 and an invisible code symbol 3 are easily printable. The invisible ink material will be later further described.

Still referring to FIG. 8, the code symbol 3 are arranged in a predetermined matrix. As described before, the code symbol 3 includes codes that encode coordinate information of each of the code symbol 3 with respect to a printed surface of the recording medium 1 as well as equivalency of the recording medium 1. For example, for the coordinate encoding mark, an upper left code symbol 3a encodes “0101” while another code symbol 3b encodes “0102.” Similarly, a symbol 3c encodes “0103” while yet another code symbol 3d encodes “0201.” Another exemplary way of encoding these code symbols 3a, 3b, 3c and 3d is respectively indicating “aa,” “ab,” “ac” and “ba.” Although it is not limited to the above described encoding scheme or positional arrangement, it is preferred to periodically place the code symbol 3 as shown in FIG. 8. A more detailed exemplary arrangement is to set the upper left corner of the recording medium 1 as an origin, an x axis to the right of the origin and an y axis below the origin. In the above coordinate system, the center of the code symbol 3a encoding “0101” is placed at x=10 mm and y=10 mm while the center of the code symbol 3b encoding “0102” is placed at x=10 mm and y=20 mm. Similarly, the center of the code symbol 3d encoding “0201” is placed at x=20 mm and y=10 mm. Although FIG. 8 shows an exemplary QR code for optically readable code symbol, there are other optically readable code symbols such as CodeOne, AztecCode and MaxiCode and the code includes any others including one dimensional codes and custom codes. Although it is desired to place the code symbols in most areas of the recording medium 1, it is not necessary to have them all over the surface of the recording medium.

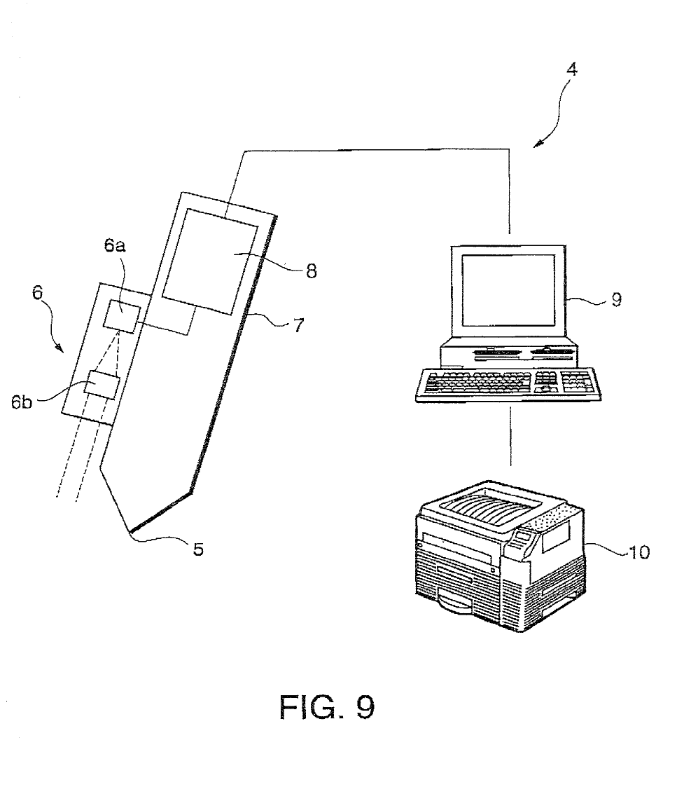

Referring to FIG. 9, a block diagram illustrates one preferred embodiment of the coordinate input unit according to the current invention. The coordinate input unit 4 includes a writing instrument 7 that is hand held for normal writing operation. At the tip of the writing instrument 7, a writing device such as a ball-point pen or mechanical pencil is optionally placed. The writing instrument 7 further includes an image reading unit 6 that is located on the side of the writing instrument 7. The image reading unit 6 includes an opto-electro conversion element 6a such as CCD and an optical system such as a lens for reading image on the recording medium 1. The image recording medium optionally farther includes a light unit for lighting the recording medium 1. The writing instrument 7 has an on-board microprocessor 8 for processing image data that is read by the image reading unit 6. That is, the microprocessor 8 decodes the code symbol 3 in order to determine the position, tilt and distortion of the code symbol 3 and implements a decoding means as well as a distortion detection means. The microprocessor 8 is also optionally connected to an external processing unit 9 such as a personal computer outside the writing instrument 7 in order to output the data in the microprocessor 8 to the external processing unit 9. Alternative to the on-board microprocessor 8 on the writing instrument 7, the image reading unit 6 is optionally connected to the information processing unit 9 in connection with a printer 10, and the preprocessing is performed at the information processing unit 9. A power source and an interface unit among the above described units are not shown in FIG. 9. It is preferred to have a detection unit for detecting a contact of the tip 5 of the writing instrument 7 on a writing surface. That is, the pen tip 5 is movable along a pen axis, and the pen tip 5 moves upon touching a writing surface so that the contact is mechanically or electronically detected. The above described detection technology is applied to a pen used in conjunction with a tablet and known in the relevant art.

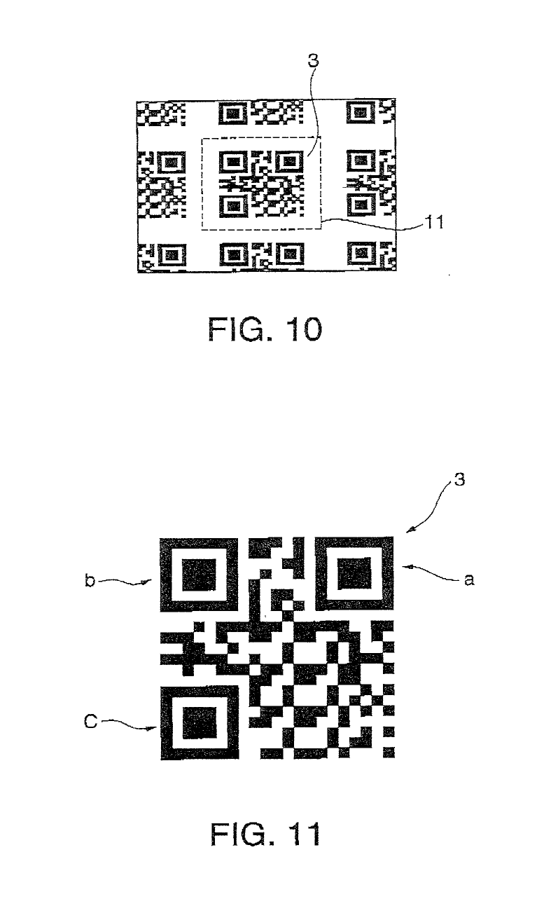

Referring to FIG. 10, a diagram illustrates one example of an image on the recording medium 1 as shown in FIG. 8 that is read by the coordinate input unit 4 according to the current invention. The coordinate input unit 4 has a scanning size range that is at least twice the size of the code symbol 3 so that at least one code symbol 3 is within the scanning range. For example, if one code symbol 3 is read within a frame 11 and the coordinate information decoded by the microprocessor 8 is “0102,” the coordinate input unit 4 detects the coordinate position on the recording medium 1 at least at the frame size 11. The disclosures of Japanese Laid Patent Publication 61-296421 has been incorporated in the current application by external reference. Since the resolution is relatively small and ranges from several millimeters to one centimeter, the practical use is limited. In order to increase the resolution, since the code symbol 3 is reduced in size by increasing the resolution of a printer and the image reading unit 6, the practical use is also limited. It is also costly to print the code symbol 3. The microprocessor 8 of the preferred embodiment according to the current invention processes the image as shown in FIG. 10 and determines the position, tilt and distortion of the code symbol 3. That is, in addition to the coordinate data area, the code symbol 3 includes a special pattern area to help determine the position, tilt and distortion of the code symbol 3.

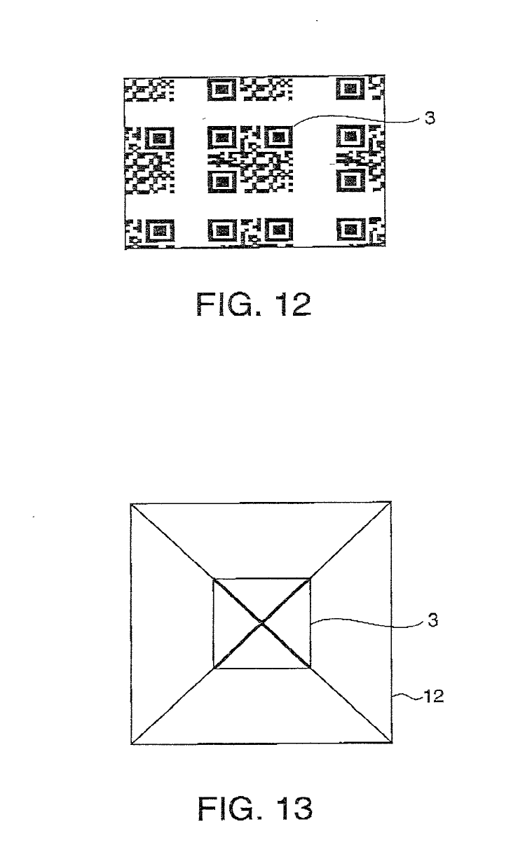

For example, FIG. 11 illustrates one example of the special pattern area. The code symbol 3 is a QR code and the three special areas a, b and c are detected to determine the position, tilt and distortion of the entire code symbol 3 on the image surface based upon the positional and size relation of the special areas a, b and c. To simplify the description, it is assumed that the central point of the image is at the tip 5 and the pen tip 5 is perpendicular to the writing surface. As shown in FIG. 12, when a two dimensional code is decoded from an image, the code symbol 3 is decoded to obtain the coordinate information such as “0102.” On the other hand, FIG. 13 shows a positional relationship between an image 12 and a code symbol 3. The center of the image 12 and that of the code symbol 3 coincide. That is, the offset between the two centers is zero. Since the position of the printed code symbol 3 is already known, based upon the detected information, for example, the code symbol, “0102” is located at x=10 mm and y=20 mm. Furthermore, since the center of the code symbol 3 and that of the image 12 coincide, the tip 5 is also located at x=10 mm and y=20 mm.

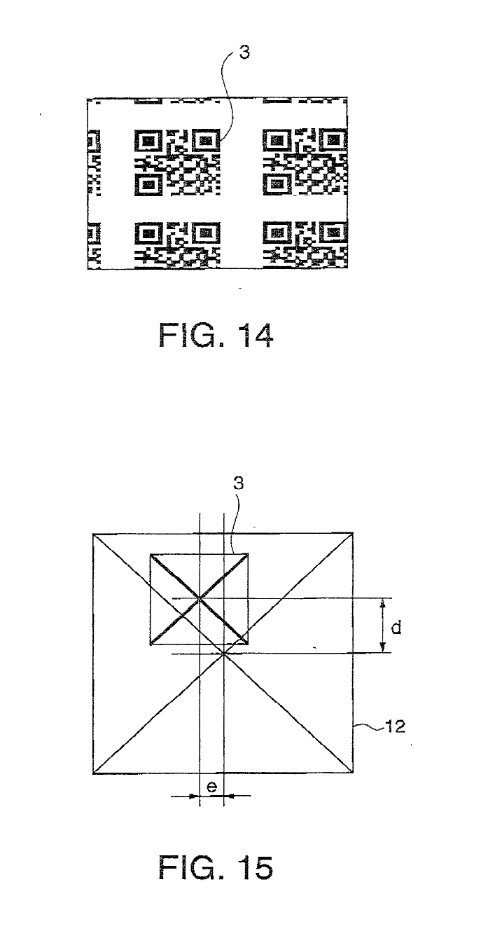

Referring to FIG. 14, another example of the image 12. FIG. 15 is a figure for the image 12 in the second example that correspond to FIG. 13. In this second example, the center of the code symbol 3 is off the center of the image 12. In fact, the center of the code symbol 3 is located from the image center by a first offset value d and a second offset value e. The offset values correspond to a number of pixels.

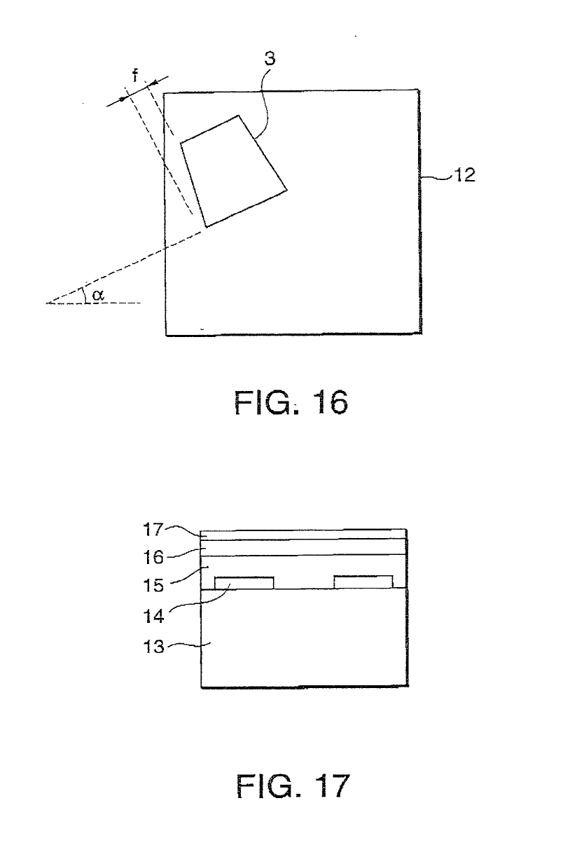

Furthermore, since the code symbol 3 has known measured values, the offset values d and e are also calculated. For example, if the offset values d and e are respectively determined to be 2 mm and 5 mm, the coordinates of the pen tip are also determined to be x=12 mm and y=15 mm. Although the example as shown in FIGS. 12 and 14 is illustrated as an ideal image for simplification, in the image as read by the image reading unit 6, the code symbol 3 is generally tilted or distorted. FIG. 16 shows that the code symbol 3 is indicated only by an outside frame. By the tilt amount a of the code symbol 3, the rotated amount of the writing instrument 7 is determined. Furthermore, the distortion amount f of the code symbol 3, the tilted amount of the writing instrument 7 is determined. Although the tip portion 5 is not necessary at the image center, since the relation between the image 12 and the tip portion 5 is constant, the relationship is also determined. Thus, based upon the decoded data of the code symbol 3, the code symbol 3 position and the calculated tilt and distortion amount, the position of the pen tip 5 is better determined and a coordinate detection means is implemented.

By using the above described coordinate input device 4, the position of the pen tip 5 on the recording medium 1 is continuously determined so that the moving trace of the pen tip 5 is obtained. In addition, based upon a pen touch detection device for detecting the contact on the writing surface, the writing trace of the writing instrument 7 on the recording medium 1 is determined. The memory unit of the microprocessor 8 or the information processing unit 9 stores the above determined writing trace data.

The code symbol 3 encodes the above described equivalent information regarding the recording medium 1. In performing the image formation on the recording medium 1 using the printer 10, assuming the printer 10 has the same components as the printer 212 as described with respect to FIGS. 2 and 3, the equivalency information in the code symbol 3 is read. The image source specifying information for specifying an image and the equivalency information of the recording medium 1 are corresponded and store in the mapping file 213 as shown in FIG. 6. For example, the image source specifying information is “c:¥MyDocument¥Patent.doc,” which is a path name to a particular file. In response to a writing operation using the writing instrument 7 on the recording medium 1 after an image has been formed on the recording medium, the coordinate information and the equivalent information of the recording medium 1 are inputted into the coordinate input unit 4. The microprocessor 8 and the information processing unit 9 searches for the corresponding path name 213c in the mapping file 213 based upon the inputted equivalent information as a search key. For example, as the result of the above search, the information processing unit 9 obtains the following image source specifying information as well coordinate information: “c:¥MyDocument¥Patent.doc,” “10, 10,” “10, 11,” “10, 12.5,” “11, 14” and so on. Furthermore, before the writing operation on the recording medium 1, the ink color to be used with the writing instrument 7 is optionally determined.

When a certain color is selected, the selected color is used to render not only the existing characters and diagrams but also to the newly generated writing. For example, if the selected color is red and an ink cartridge is switched to a red ink cartridge in the writing instrument 7, the coordinate input unit 4 detects the red ink. One exemplary implementation for the ink color detection includes a mark indicative of the red color on the ink cartridge and a sensor on the writing instrument reads the mark to determine the red color ink. After receiving the above described information such as “c:¥MyDocument¥Patent.doc,” “10, 10,” “10, 11,” “10, 12.5,” “11, 14,” the coordinate input unit 4 adds the selected color information to generate the following information: “redc:¥MyDocument¥Patent.doc, 10, 10∞ or “¥MyDocument¥Patent.doc,red, 10, 10” Similarly, the coordinate input unit 4 generates: “redc:¥MyDocument¥Patent.doc, 10, 11” “redc:¥MyDocument¥Patent.doc, 10, 12.5” “redc:¥MyDocument¥Patent.doc, 11, 14”

The memory unit of the microprocessor 8 stores the above obtained coordinate information, the document information and the color information, and the same information is transferred to the information processing unit 9. Alternatively, the above information is generated at the information processing unit 9. The information processing unit 9 stores in its hard disk the original information source from which an image is formed on the recording medium 1. The information processing unit 9 opens the image source and updates the above coordinate information, the document information and the color information for the newly added information on the recording medium 1 as if they were written on the recording medium 1. According to the preferred embodiment, since the original document or image source is unambiguously identifiable and the writing trance is available, the newly added information by the writing instrument is automatically added to the original document or the image source. That is, based upon the image source specifying information such as a document name and a path name, the original document or image source are electronically read, and the coordinate information of the writing trace and the selected color information are added to the original source. The document editing system for adding the coordinate information, the writing trace information and the color information to the original document is implemented by the above described coordinate input unit 4. Alternatively, prior art word processor software is used for implementing certain macro functions. The addition of the writing trace to the original document file is not necessarily a real time process. For example, the writing trace data is temporarily store in the memory of the microprocessor 8, and the microprocessor 8 is later connected to the information processing unit 9 for processing the stored writing trace data. In this situation, it is preferred that a user is asked for confirmation before the writing trace data is added to the original file. It is also preferred that the user is able to select the original source file via the information processing unit 9. Even if there is no equivalency information for the image source, the document editing system according to the current invention selects an appropriate original source file and updates with the newly added information.

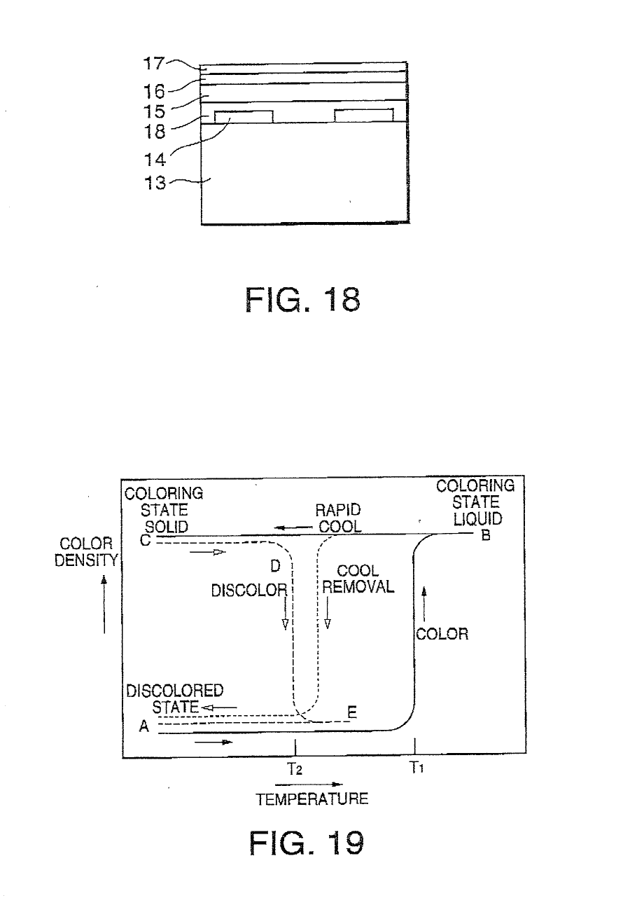

Referring to FIG. 17, a diagram illustrates one preferred embodiment of an erasable or reusable recording medium 1 according to the current invention. The recording medium 1 includes a support layer 13, a code symbol layer 14 located above the support body 13 for containing the code symbol, a recording layer 15, a middle layer 16 and a protection layer 17. The support layer 13 is made of white resin that has a good heat transmission characteristic while the middle layer 16 and the protection layer 17 is made of transparent resin. As shown in FIG. 18, in order to use heat in an efficient manner, between the support layer 13 and the recording layer 15, a lower layer is provided for shielding heat. The lower layer 18 is formed by spraying organic or inorganic micro hollow particles with biding resin. The code symbol 3 indicative of the coordinate information on the writing trace and the equivalency information is provided on the lower layer 18. Furthermore, an under coat layer is optionally provided to improve the cohesiveness between the support layer 13 and the recording layer 15 and to prevent the recording layer material from leaking into the support layer 13. As described above, the image of the code symbol 3 is formed by invisible ink. In addition to the coordinate information, when there is a need for classifying a large number of various documents, since the bar code lacks the capacity to cover the large number of classification, a two dimensional code is utilized. By using the two dimensional expansion, twenty rows of cod are generated, and a unique serial ID is assigned to every recording medium that is used in the world. That is, a unique ID number is given to an every document in the world. The document ID is also optionally made invisible by using invisible material so that security of the document is promoted.

Since a unique ID is used for the equivalent information upon generating each of the recording medium 1, when the recording medium 1 is printed, the image source specifying information for the desired document 2 needs to be corresponded to the equivalent information containing the unique ID. As described above, for example, the ID information includes a file path name such as “c:¥MyDocument¥Patent.doc.” The above mapping leads to the information on printing which document 2 on which recording medium 1. After editing using the current system, the newly added information is updated in the original document file. That is, against a recording medium 1 having the equivalency information of “123456,” the printer 10 connected to the information processing unit 9 as shown in FIG. 9 prints the document 2 having the identification, “c:¥MyDocument¥Patent.doc.” The corresponding mapping information is stored in the mapping file 213 as shown in FIG. 6. The information processing unit 9 automatically maps between “123456” and “c:¥Document¥Patent.doc” and implements the mapping means. For this reason, when a user writes on the printed recording medium by using the coordinate input unit 4, the equivalent information read by the image reading unit 6 and the above corresponded information in the information processing unit 9 are referenced via the mapping file 213. The image source or document data that is printed on the recording medium 1 is called, and the coordinate information read by the image reading unit 6 and the color information are automatically added to the image source to be updated. As described above, when red ink is used in the coordinate input unit 4 and the document information of the recording medium 1 and the coordinate information are inputted as data such as “123456,” “10, 10,” “10, 11,” “10, 12.5,” and “11, 14,” the coordinate input unit 4 generates the following data based upon the color information, the document information and the coordinate information. “red¥123456,10,10” or “1234356, red, 10,10”; “red¥123456,10,11”; ¢red¥123456,10,12.5”; and “red¥123456,10,14” The above information is transferred to the information processing unit 9, the added information is rendered in red on the original document “c:¥MyDocument¥Patent.doc” that is specified by the above associated information, “123456” and “c:Eq¥Document¥Patent.doc.” The above described process is performed by the printer 10 that is connected to the information processing unit 9 or the information processing unit 9 itself.

The recording layer 15 is a reversible recording layer for reversibly displaying the visible information and includes a thermal method, an electromagnetic method, a photo chromic recording method, and an electro chromic method. The preferred embodiment according to the current invention the thermal method for causing a change in the optical characteristic to record or erase the visual information in the recording layer 15. The thermal energy-based writing is done by a thermal sublimation printer. The reversible recording material by the thermal energy is a recording layer including at least leuco dye and developer, a resin layer including organic low molecular compound particles and a reversible recording layer composed of a recording layer including low or high molecular liquid crystal compound. For example, the reversible recording layer containing leuco dye and developer is formed by dispersing the leuco dye and the developer in binder. The leuco dye includes compounds such as xxxxxxx. Japanese Laid Publication Hei 5-124360 discloses prior art leuco dye. The developer has a function to color the leuco dye within molecules and include phenol hydroxide, carboxylic acid group and phosphoric acid group that control molecular cohesion force and have long hydrocarbon groups. The combined portion include hetero atoms bivalent groups, and the long hydrocarbon groups may include hetero atoms bivalent groups or aromatic hydrocarbon groups. The developer disclosed in Japanese Patent Laid Publication Hei 5-124360 is used.

The recording layer 15 is a resin layer that includes at least leuco dye and developer. The resin for forming the recording layer 15 includes for example, ploy vinyl chloride, ploy vinyl acetate, ploy vinyl chloride-ploy vinyl acetate copolymer, poly vinyl acetal, poly vinyl butyral, polycarobonate, poly acryxxx, poly sulfone, poly ester sulfone, poly phenylen oxide, fluorine resin, polyimide, polyamide, polyamideimide, poly benzimidazole, polystyrene, styrene copolymer, phenoxide resin, polyester, aromatic polyester, polyurethane, polyacrylic acid ester, polymethacrylic acid ester, (meth) acrylic acid ester copolymer, maleic acid copolymer, epoxy resin, alkyd resin, silicon resin, phenol resin, poly vinyl alcohol, modified poly vinyl alcohol, poly vinyl pyrrolidone, polyethylene oxide, polypropylene oxide, methyl cellulose, ethyl cellulose, carboxy methyl cellulose, hydroxy ethyl cellulose, starch, gelatin, and casein. In order to strengthen the coat of the above recording medium, various hardening agents and bridging agents are added. The hardening and bridging agents include compounds containing isocyanate groups, polyarnide epichlorohydrin resin, compounds containing epoxy groups, glyoxal, and zirconium compounds. The recording layer is formed with electron radiation hardening binders or ultraviolet radiation hardening binders, and these binders include compounds that contain ethylene unsaturated linkage. Concrete examples include 1) poly (meth) acryxxx such as aliphatic, alicyclic, aromatic and aroma-aliphatic polyhydric alcohol and poly alkylane glycol; 2) poly (meth) acryxxx with polyalkylane oxide such as aliphatic, alicyclic, aromatic and aroma-aliphatic polyhydric alcohol and poly alkylane glycol; 3) polyester poly(meth)acrylate; 3) poly (meth) acryxxx; 4) polyurethane poly (meth) acryxxx; 5) epoxy poly (meth) acryxxx; 6) polyamide poly (meth) acryxxx; 7) poly (meth) acryxxxoxyalky phosphoric acid ester; 8) vinyl or diene compound having (meth) acryxxx group in a side chain or at a terminal; 9) monofunctional poly (meth) acryxxx, vinyl pyrrolidone, poly (meth) acryxxx compound; 10) cyanic compound containing an ethylene unsaturated linkage; 11) mono or polycarbon acid, alkali metal salt, ammonium salt or amine salt containing an ethylene unsaturated linkage; 12) acryl amid or alkyl displacement (meth) acryxxx amid and other coplymer; 13) vinyl lactam or poly vinyl lactum compound; 14) polyether or polyester containing an ethylene unsaturated linkage; 15) alcohol ester containing an ethylene unsaturated linkage; 16) poly arugol ester containing ethylene unsaturated linkage; 17) aromatic compound containing more than ethylene unsaturated linkage such as styrene or vinyl benzene; 18) poly organosiloxane compound having (meth) acryxxx group in a side chain or at a terminal; 19) silicon compound containing ethylene unsaturated linkage; and 20) copolymer of the compounds of 1) through 19) or modified oligoester. When an ultraviolet radiation binder is used for forming the recording layer 15, a high polymer initiating agent is mixed in the binder. The high polymer initiating agent includes acetophenone such as di- or trichloroacetophenone, 1-hydroxycyclohexyl phenylketone, benzophenone, Michler's ketone, benzpin alkylether, benzyl dimethyl xxxx, tetramethylxxxxmonosufite, xxxxx, azo compound, di-aryl idonium salt, tri-aryl sulfonium salt, bis (trichloromethyl) tri-azine compounds.

Referring to FIG. 19, a graph illustrates that the recording layer 15 containing the leuco dyne and the developer, colors and discolors according to the predetermined processes. When an initial discolored state A is heated beyond the temperature TI, the leuco dyne and the developer fuse and mix in order to show a color in a state B. When the state B is rapidly cooled, the color is preserved while being fixed in a state C. When the colored state C is heated, the color disappears in a state D at a temperature T2 that is lower than the initial color causing temperature T1. When it is cooled again, the initial discoloration is obtained. If the recording layer 15 contains a resin layer including organic low molecular compound, the recording layer reversibly changes its transparency depending upon the temperature. The recording layer 15 utilizes the temperature-dependent reversible light scattering characteristics. The resin used in the recording medium 15 forms a uniformly distributed organic low molecular compound and affects the transparency degree at the maximum transparency. The primary resin has high transparency as well as good coat generation characteristic and is mechanically stable. The desired primary resin includes heavy vinyl copolymers such as ploy vinyl chloride, ploy vinyl chloride-acetic acid vinyl copolymer, ploy vinyl chloride-acetic acid vinyl-vinyl alcohol copolymer, ploy vinyl chloride-acetic acid vinyl maleic acid copolymer and ploy vinyl chloride-acryxxx copolymer; poly vinylidene chloride copolymers such as poly vinylidene chloride, poly vinylidene chloride- vinyl chloride copolymer, vinylidene chloride-acryxxx copolymer; polyester; polyamide; polyacraxxx or polymeth acryraxxx copolymer; and silicon resin. These are used as a single material or a mixture of materials.

The low molecular compound used in the recording layer 1 generally has a fusion point at 30° C. to 200° C. and.preferably 50° C. to 150° C. The low molecular compound includes alxxx, alkanedixx, halogen alkaxxx, or halogen alkanedixx; alkyl amine; alkane; alkene; anolekene, halogenalkane; halogenalkene; halogenalkyne; cycloalkane; cycloalkene; cycloalkyne; saturated or unsaturated mono or dicarboxylic acid or ester, amide and anmonia salt; allylcarboxylic acid or ester, amide and anmonia salt; halogen allylcarboxylic acid or ester, amide and anmonia salt; thioalcohol; thiocarboxylic acid or ester, amide and anmonia salt; carboxylic ester. These are used as a single material or a mixture of materials. The number of carbons in these compounds ranges from 10to 60, preferably ranges from 10 to 38, and the most preferably from 10 to 30. The alcohol group in the ester is either saturated or unsaturated and is optionally halogen displaced. In any case, in the organic low molecular compounds, the molecules include at least oxygen, nitrogen, sulfur and halogen such as —OH, —COOH, —CONH, —COOR, —NH, —NH₂, —S—, —S— S—, —O—, and halogen. Furthermore, in order to broaden the temperature range, the above described compounds are combined or organic low molecular compounds and other material having a different fusion point are combined. Although Japanese Patent Publications 63-39378, 63-130380, 63-14754 and 1-140109 disclose some of the above combinations, the combinations are not limited to these disclosures.

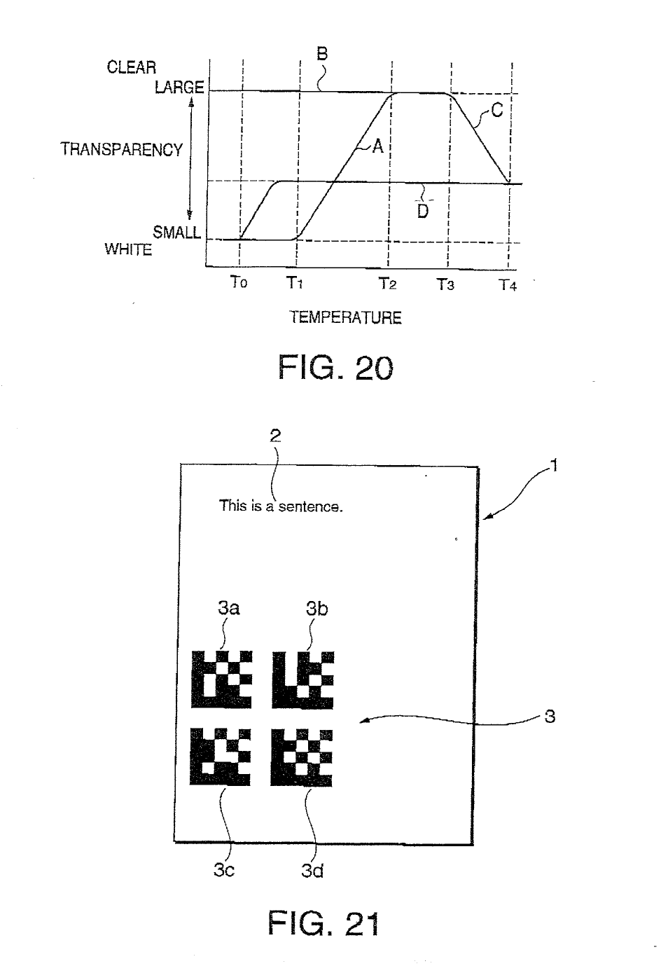

Referring to FIG. 20, a graph illustrates a process in which the recording layer 15 having organic low molecules and resin changes its color from transparency to white depending upon the temperature. The reversible recording layer 15 includes a certain resin and a certain organic low molecular compound that is dispersed in the resin. For example, the reversible recording layer 15 is white and non-transparent under a room temperature T0 and becomes transparent above a predetermined temperature T2 as indicated by a first line A. After having become transparent, the recoding layer 15 remains transparent even if the temperature goes below the room temperature T0 as indicated by a second line B. However, when the recording layer 15 is heated beyond a predetermined high temperature T3, it now obtains a mid-transparency between the maximal transparency and the minimal transparency as indicated by third line C. Subsequently, if the temperature is lowered, the recording layer 15 regains its initial white appearance state as indicated by a fourth line D. Furthermore, although it is not shown in the graph, after the temperature change of the fourth line D, if the temperature is raised between the degrees T1 and T2 and then lowered below the degree T0, the mid-transparency is obtained. However, after the second line B below the temperature T0, the transparency disappears and the white color returns to the recording layer 15 when it is heated beyond the temperature T3.

The recording layer 15 includes low molecules or high molecular crystal, and the high molecular crystal includes main or side chained molecular that links mesogen to the main chain or side chain for indicating crystal characteristics. The high molecular crystal is generally manufactured by polymerizing with mesogen compound called mesogen monomer or by adding the monogen monomer that is able to react with a reactive polymer such as polysilicon hydroxide. The above technology is disclosed in Markromol. Chem. 179, p 273 (1978); Eur, Poly. J., 18, p 651 (1982) and Mol. Cryst. Liq. Cryst. 169, p 167 (989), and the high molecular crystal to be used in the current invention is manufactured by the above disclosed methods. Mesogen monomer or reactive mesogen compound includes compounds of unbending molecules such as biphenyl group, phenylbenzoate group, cyclohexyl benzene group, azoxybenzene group, azobenzene group, azoxxxx, phyenl pyrimidine group, diphenyl acetylene group, biphenylbenzoate group and cyclohexylbiphenyl group that are linked to acrylic acid ester group, ester methacrylate group or vinyl group-via a predetermined alkyl spacer.

Lastly, the optically detectable invisible material absorbs some light and is detectable due to the difference in reflection strength. Alternatively, by absorption of light, light is generated, and the generated light is detected. The former material absorbs little light in the visible light range, but absorbs more light outside the visible light range. The above coordinate information and document information are indicated by the above described light absorbing and reflecting material. By the optical density difference outside the visible light, the information is detected. Since the optical density difference is nminute outside the visible range, a human can hardly see the marks. It is preferred that infra red light is used since ultraviolet light tends to damage compounds used in the recording medium. The organic infra red material includes cyanine coloring agent, phthalocyanine coloring agent, anthraquinone coloring agent, dixxxxx coloring agent and triphenylmethane coloring agent. Since these agents absorb visible light, they appear to be a reddish creamy color. For this reason, it is even preferred to have inorganic material that does not absorb light in the visible light range but do absorb light in the infrared light range. For example, the above inorganic material includes at least Nd, Yb, In, Sn and Zn and is a compound such as oxides, sulfide and halogenide. These compounds have white or light blue color and help the code carrying symbol appear invisible. The concrete examples include ytterbium oxide, tin oxide, zinc oxide, ytterbium sulfide, zinc sulfide, ytterbium chloride, indium chloride, heavy tin, zinc chloride, ytterbium bromide, indium bromide, indium-zinc mixed oxide, indium-zinc mixed oxide and one of a group of alumina, barium sulfate, silicon dioxide and calcium carbonate.

For efficient infrared absorbing material, Yb, In, Sn and Zn are included with acid and salt. Some concrete examples include ytterbium sulfide, zinc sulfide, indium sulfide, ytterbium nitrate, tin nitrate, perchloric acid ytterbium, ytterbium carbonate, zinc carbonate, indium carbonate, ytterbium acetate, zinc acetate, tin acetate, nicotinic acid ytterbium, ytterbium phosphate, zinc phosphate, tin phosphate, ytterbium oxalate, zinc oxalate and tin oxalate. By absorbing light, fluorescent light is emitted, and a certain material detects the fluorescent light by its fluorescent wavelength and the strength difference. Because of the deterioration in light resistance to ultraviolet light of the material contained in the recording medium, it is preferred to have a material that is excited by the infrared light and emits fluorescent light. The above described material includes an active chemical element such as organic metal compound containing at least Nd, and the organic compound is selected from carboxylic acid group, keton group, ether group, amine group. Concrete examples of these organic compounds include cinnamic acid neodymium and naphthoic acid neodymium. Furthermore, an active chemical element includes an organic metal compound including Nd or Yb, and concrete examples include cinnamic acid neodymium, ytterbium double salt, benzoic acid neodymium ytterbium double salt and naphthoic acid neodymium ytterbium double salt. An oxygen contained acid-base compound that includes at least one of Nd, Yb and Er is used as an infrared fluorescing material. Concrete example of oxygen contained acid-base compounds include phosphate compounds, vanadate compound, boric acid heavy compound and molybdic acid chloride compound. Other compounds are also used as an infrared fluorescing material, and they include Fe or Er as an optical active element as well as at least one of Sc, Ga, Al, In, Y, Bi, Ce, Gd, Lu and La. Another infared fluorescing material is a compound that includes Yb as an optical active element and at least one of Sc, Ga, Al, In, Y, Bi, Ce, Gd, Lu and La.

Yet another infrared fluorescing material is a compound that includes an organic compound for absorbing the infrared light and at least one rare metal organic compound from Nb, Yb and Er. The infrared absorbing organic compound includes polymxxx, anthraquinone group coloring agent, dixxxxx coloring agent, phthalocyanine group coloring agent, indophenol group coloring agent and azo group coloring agent.

Now referring to FIG. 21, a diagram illustrates a second preferred embodiment of the recording medium to be used with the information system according to the current invention. The recording medium 1 A records a document in a visible format and generally is a sheet made of paper, cloth and plastic. Information 2 is visible and includes character, text, figures, diagrams and tables. Code symbol 3 is optically readable and includes bar code and two dimensional code. The light absorbing wavelength and light emitting wavelength are not overlapping between the information 2 and the code symbol 3.

The information is within the human visible wavelength rage. Although the code symbol 3 is outside of the visible range, it is optically readable. Under the above arrangement, even though the information 2 and the code symbol 3 are printed in an overlapping manner, they are independently read. As an example of invisible ink is stealth ink from HitachiMaxell, and a recording medium for a thermal transfer printer is also available. The stealth ink is almost invisible to human eyes while it is optically readable under the infrared light. Conversely, certain ink is transparent or invisible under the infrared light while it is black outside the infrared light range. The use of the combination of the above described two ink allows to print the visible information 2 and the invisible code symbol 3.

Still referring to FIG. 21, the code symbol 3 is arranged in a predetermined matrix on the recording medium 1 and encodes the coordinate information of the code symbol 3. For example, the upper left code symbol 3a, the code symbol 3b, the code symbol 3c and the code symbol 3d respectively encode “0101,” “0102,” “0201” and “0202.” Another example is that the upper left code symbol 3a, the code symbol 3b, the code symbol 3c and the code symbol 3d respectively encode “aa,” “ab,” “ba” and “bb.” As long as each of a plurality of the code symbols 3 identifies unique information, the encoded information or the arrangement is not limited to the above example. However, it is preferred to arrange and encode in a predictable manner. If the upper left corner of a sheet is an origin, the right of the origin is an X axis while the lower of the origin is a Y axis.

Within the above XY axes, the center of the code symbol 3a having the “0101” information is located at 10 mm and 10 mm. Similarly, the center of the code symbol 3b having the “0102” information is located at 10 mm and 20 mm while the center of the code symbol 3c having the “0102” information is located at 20 mm and 10 mm. Although FIG. 21 shows an exemplary Matrix code for optically readable code symbol, there are other optically readable code symbols such as CodeOne, AztecCode and MaxiCode and the code includes any others including one dimensional codes and custom codes. The code symbol 3 further encode logical information such as a first chpter, a second section, a fith paragraph and a sixth character as encoded by “01020506.” Although it is desired to print the code symbol 3 in a wide range of area on a sheet of the recording medium 1, it is optionally limited to print the code symbol 3 to a print margin where information is not generally printed. The code symbol 3 encodes both the coordinate information on the recording medium 1 and the equivalent information. A different set of the code symbols 3 for the equivalent information is optionally placed on the recording medium 1. For example, in a two dimensional format, the code symbol 3 is approximately a few millimeters in size to contain the above described both types of information.

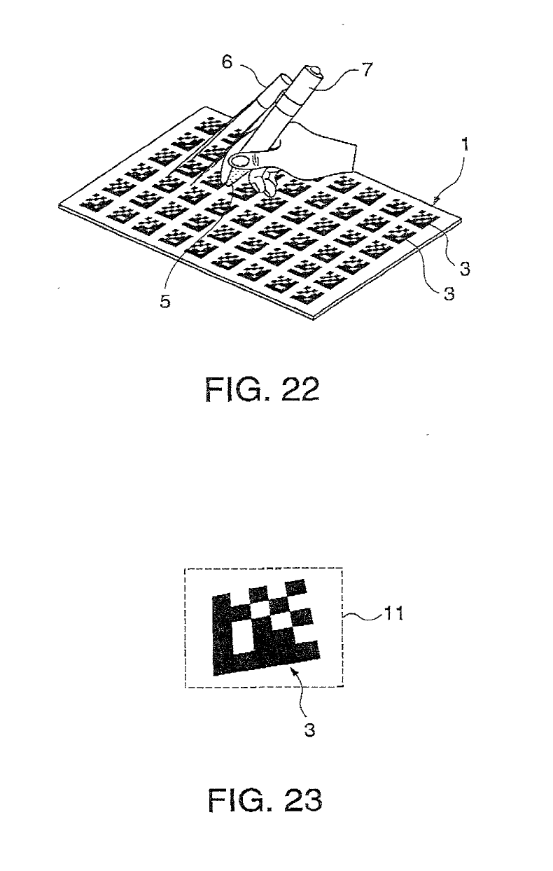

Now referring to FIG. 22, a perspective view illustrates that a user holds the writing instrument 7 and writes over the recording medium 1. The coordinate input unit 4 to be used in the information processing unit according to the current invention has been described with respect to FIG. 9. The coordinate input unit 4 includes the writing instrument 7. At one end 5 of the writing instrument 7, an actual writing mechanism such as a ball point pen and a mechanical pencil is optionally installed. An image-reading unit 6 located on the side of the writing instrument 7 reads images on the recording medium 1 and includes for example an opto-electorical conversion element 6a and an optical system 6b such as lenses. A lighting unit is optionally placed on the image-reading unit 6. The writing instrument 7 includes a microcomputer 8, and the microcomputer 8 is connected to the image-reading unit 6. The microcomputer 8 performs various tasks on the image data that is read by the image-reading unit 6. That is, the various tasks include decoding of the read code symbol 3 to determine the position, the tilt angle and the distortion of the code symbol 3. These functions by the microcomputer 8 implement a decoding means and a distortion determination means. The microcomputer 8 is also optionally connected to an information processing unit 9 such as a PC external to the writing instrument 7 and outputs the information stored in the writing instrument 7 to the information processing unit 9. Alternative to the on-board microprocessor 8 on the writing instrument 7, the image reading unit 6 is optionally connected to the information processing unit 9, and the preprocessing is performed at the information processing unit 9. A power source and an interface unit among the above described units are not shown in FIG. 9. It is preferred to have a detection unit for detecting a contact of the tip 5 of the writing instrument 7 on a writing surface. That is, the pen tip 5 is movable along a pen axis, and the pen tip 5 moves upon touching a writing surface so that the contact is mechanically or electronically detected. The above described detection technology is applied to a pen used in conjunction with a tablet and known in the relevant art.

Now referring to FIG. 23, a diagram illustrates an exemplary image that is read from the recording medium l as shown in FIG. 21 by the coordinate input unit 4. The coordinate input unit 4 has a scanning size range that is at least twice the size of the code symbol 3 so that at least one code symbol 3 is within the scanning range. In reality, adjacent code symbols 3 are also within in the scanning size range, FIG. 23 does not show these adjacent code symbols 3. As shown in FIG. 22, since the scanning image surface of the image-reading unit 6 and the recording medium surface 1 are not necessarily parallel with each other, the read image of the code symbol 3 is distorted as shown in FIG. 23. For example, the code symbol 3 within a frame 1 1 is read, and the coordinate information contained in the code symbol 3 is decoded by the microcomputer 8. If the decoded result is “0102,” the coordinate input unit 4 is able to determine the coordinates on the recording medium 1 at accuracy of at least the size of the frame 11. For the determination of the coordinates, Japanese Laid Patent Publication 61-296421 is incorporation by external reference. Since the resolution is relatively small and ranges from several millimeters to one centimeter, the practical use is limited. In order to increase the resolution, since the code symbol 3 is reduced in size by increasing the resolution of a printer and the image-reading unit 6, the practical use is also limited. It is also costly to print the code symbol 3.

In the second preferred embodiment, the microprocessor 8 processes the frame 11 of the image read by the image-reading unit 6, and the position, tilt and distortion amount of the code symbol 3 in the frame 11. As described with respect to the first preferred embodiment, when the two-dimensional code is decoded, for example, the data, “0102” is obtained. Since the printed position of the code symbol 3 is already known, the center of the code symbol for “0102” is at 10 mm and 20 min respectively on the X axis and the Y axis. We also know the size of the code symbol 3. Assuming the size is 5 mm in both width and length, the coordinates of the four comers of the code symbol 3 is respectively 7.5 mm, 17.5 mm; 7.5 mm, 22.5 mm; 12.5 mm, 17.5 mm; and 12.5 mm, 22.5 mm. The coordinates of the four comers of the code symbol 3 are expressed by the following equation:

$${x}_{r} = \frac{{b}_{1} {x}_{s} + {b}_{2} {y}_{s} + {b}_{3}}{{b}_{7} {x}_{s} + {b}_{8} {y}_{s} + 1}$$

$${y}_{r} = \frac{{b}_{4} {x}_{s} + {b}_{5} {y}_{s} + {b}_{6}}{{b}_{7} {x}_{s} + {b}_{8} {y}_{s} + 1}$$

where r is a coordinate on the recording medium 1 while s is a coordinate on the image that is read by the image-reading unit 6. Since there are eight unknown variable, when the coordinates of the four comers of the code symbol 3 are known, the projection conversion coefficient is derived. Using the coefficient and the equation, the coordinate on the paper that corresponds to an arbitrary point on the image is determined. Thus, the coordinate that corresponds to a position of the tip 5 on the recording medium 1 is determined. The point on the image that corresponds to the tip 5 is determined based upon the relational position of the tip 5 and the image-reading unit 6. Alternatively, when the tip 5 is scanned, the coordinate is measured. In either case, since the relational position of the tip and the image-reading unit 6 is fixed, the coordinate is easily obtained. When the above described coordinate input 4 is used and the tip 5 is continuously detected, the trace of the tip 5 is obtained. As described above, if a detection unit determines whether or not the tip 5 contacts the writing surface, the trance of the tip 5 is intermittently obtained. The trace data is stored in a memory unit of the microprocessor 8 of the writing instrument 7 or is read from the information processing unit 9 in real time.

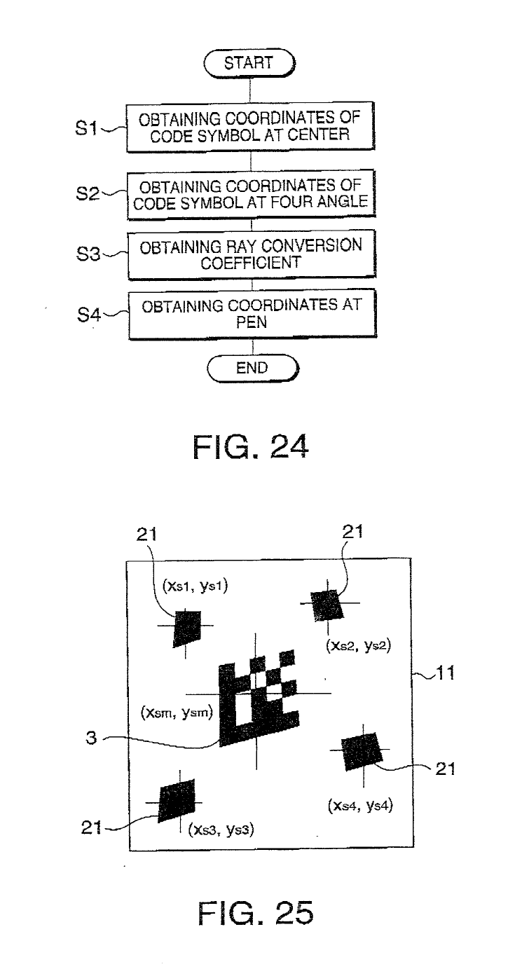

Now referring to FIG. 24, a flow chart illustrates steps involved in determining the coordinates of tip 5 on the recording medium 1 by the microprocessor 8 based upon the encoded data from the scanned image of the code symbol 3 according to the current invention. From the encoded result of the code symbol 3, the microprocessor 8 determines the coordinates of the center of the code symbol 3 on the recording medium 1 in a step S1. Based upon the coordinates of the center of the code symbol 3, the microprocessor 8 determines the coordinates of the four comers of the code symbol 3 on the recording medium 1 in a step S 2. From the coordinates of the four comers of the code symbol 3 and the coordinates on the image, the projection coefficient is determined as described above in a step S 3. Finally, using the relational position of the tip 5 and the image-reading unit 6 as well as the projection coefficient, the coordinates the tip 5 on the recording medium 1 are determined in a step S 4. The code symbol 3 encodes the equivalency information that identifies the recording medium 1. The coordinate input unit 4 searches in the mapping file 213 using the equivalent information as a key and gains the image source specifying information and the coordinate information such as “c:¥MyDocument¥Patent.doc,” “10, 10,” “10, 11,” “10, 12.5,” “11, 14” By the above information, the original document or an image source is identified and the writing trace is obtained. The new information is now easily added to the original document. From the image source specifying information such as a file name or a path name, the original document is electronically retrieved and the coordinate information for the trace is added to the retrieved file. The document editing system for adding the coordinate information, the writing trace information and the color information to the original document is implemented by the above described coordinate input unit 4. Alternatively, prior art word processor software is used for implementing certain macro functions. For example, the writing trace data is temporarily store in the memory of the microprocessor 8, and the microprocessor 8 is later connected to the information processing unit 9 for processing the stored writing trace data. In this situation, it is preferred that a user is asked for confirmation before the writing trace data is added to the original file. It is also preferred that the user is able to select the original source file via the information processing unit 9. Even if there is no equivalency information for the image source, the document editing system according to the current invention selects an appropriate original source file and updates with the newly added information.

Now referring to FIG. 25, a diagram illustrates a partial image from the recording medium 1 that is read by the image-reading unit 6 to show another exemplary detection of the coordinates on the recording medium 1. On the recording medium 1, the code symbol 3 encodes the coordinate information and the document information in a two-dimensional code as already shown in FIG. 23. Around the four corners of the code symbol 3, there are additional four symbols 21. In the first preferred embodiment, the two-dimensional code symbol 3 itself or angular portions are used to determine an amount of distortion of the image. Since the code symbol 3 is not originally designed for the distortion detection, if there is not a dot near the corners of the code symbol 3, the accuracy is not sufficient. For this reason, as shown in FIG. 25, four additional symbols 21 are placed in addition to the code symbol 3 to determine the distortion amount. Since no data is decoded from the symbol 21, the shape of the symbol 21 is preferred to be easily detectable. Although the symbols 21 are rectangular, they are not limited to the shape and include circles. By using the template matching method, the coordinates of the symbols 21 are detected. Since there are other rectangular shaped objects on the image other than the symbols 21, the extracted rectangles do not necessarily match the symbols 21 that are placed around the corresponding code symbol 3. In certain situations, the symbols 21 are extracted from the corresponding code symbol but from an adjacent one of the code symbol. However, since the distance between the image-reading unit 6 and the recording medium 1 is constant, the distance among the four symbols 21 is also approximately constant. Based upon the above relation, it is determined whether or not the symbols 21 belong to a certain one of the code symbol 3. Since the code symbol 3 and the symbols 21 are placed at the predetermined positions, the coordinates on the recording medium 1 are determined in the following manner.

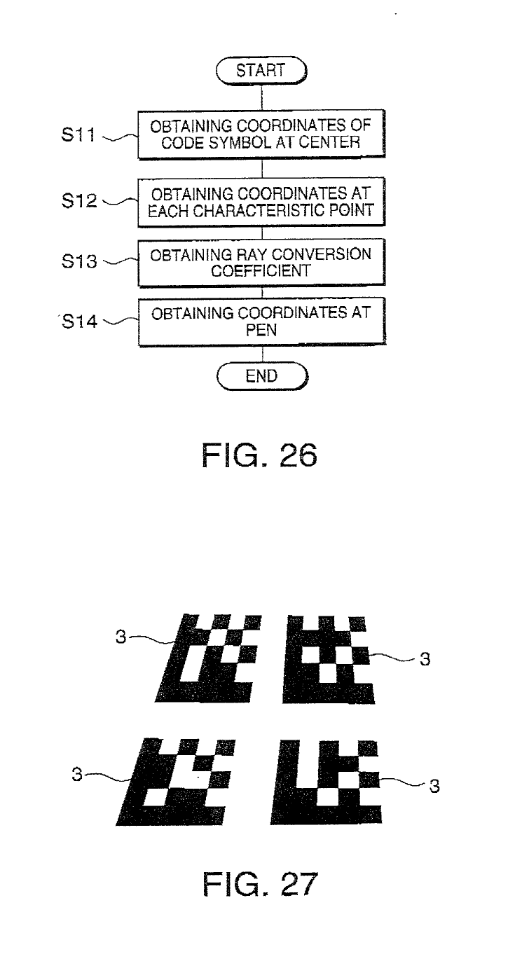

Referring to FIG. 26, a flow chart illustrates steps involved in determining the coordinates of tip 5 on the recording medium 1 by the microprocessor 8 based upon the encoded data from the scanned image of the code symbol 3 and the symbols 21 according to the current invention. From the encoded result of the code symbol 3, the microprocessor 8 determines the coordinates of the center of the code symbol 3 on the recording medium 1 in a step S11. Based upon the coordinates of the center of the code symbol 3, the microprocessor 8 determines the coordinates of the four symbols 21 on the recording medium 1 in a step S12. From the coordinates of the four symbols 21 and the coordinates on the image, the projection coefficient is determined as described above in a step S 13. Finally, using the relational position of the tip 5 and the image-reading unit 6 as well as the projection coefficient, the coordinates the tip 5 on the recording medium 1 are determined in a step S14. The step 14 implements a coordinate detection means.

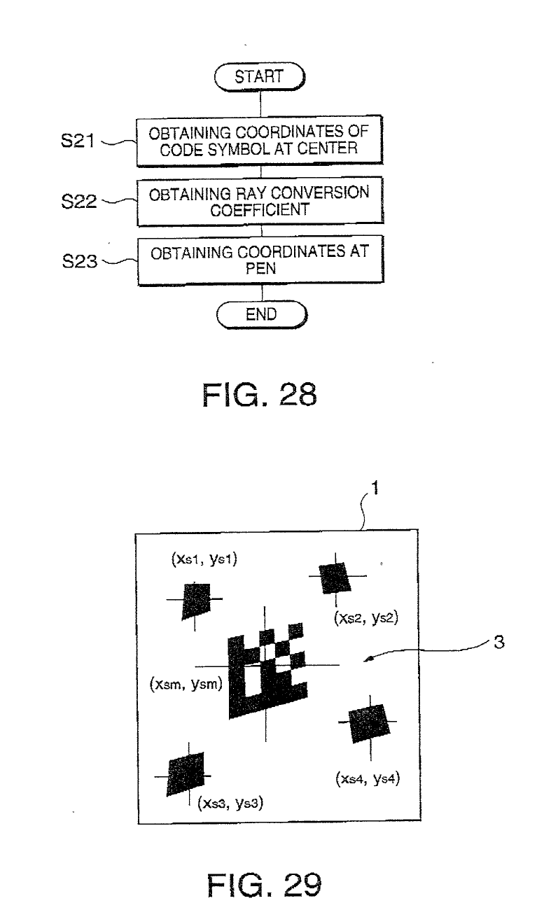

FIG. 27 illustrates that at least four of the two-dimensional code symbols 3 are scanned. As described above, the code symbols 3 encodes the coordinate information and the equivalency information. The relevant information is decoded from the encoded information, and based upon the decoded information, the coordinates of the center of each of the code symbols 3 are obtained. As described above, the detection of the two-dimensional code symbol 3 is not sufficiently accurate. To improve accuracy, the center coordinates of four of the code symbols 3 are used to determine the projection coefficient. The coordinates on the recording medium 1 are determined as follows as will be described with respect to FIG. 28.

Referring to FIG. 28, a flow chart illustrates steps involved in determining the coordinates of tip 5 on the recording medium 1 by the microprocessor 8 based upon the encoded data from the scanned image of the four code symbols 3 according to the current invention. From the encoded result of the four code symbols 3, the microprocessor 8 determines the coordinates of the center of each of the code symbols 3 on the recording medium 1 in a step S21. From the coordinates of the center of the four code symbols 3, the projection coefficient is determined as described above in a step S22. Finally, using the relational position of the tip 5 and the image-reading unit 6 as well as the projection coefficient, the coordinates the tip 5 on the recording medium 1 are determined in a step S23. The step S23 implements a coordinate detection means. In the step S12 of FIG. 26, the coordinates of the symbols 21 on the recording medium 1 are calculated by determining the positional relationships. In the above described coordinate determination steps in FIG. 28, the coordinates are determined by decoding each of the code symbol 3, and the above operation in the step S12 is eliminated for better efficiency. On the other hand, the two-dimensional code symbols 3 have to be scanned in from a wider area, the image-reading unit 6 and the optical system 6b have the corresponding wide range. For this reason, the manufacturing costs of the image-reading unit 6 for covering the wide range are higher than those of the same for covering a narrow range. The above described limitations are only exemplary, and other combinations are also used in connection with the current invention. In alternative embodiments, instead of using four code symbols 3, one of the code symbols 3 is used to determine the center coordinates. Another example is that more than four symbols 21 are used, and the mean error square method is utilized to determine the conversion coefficient for determining the tip 5 coordinate position on the recording medium 1 at a high precision level.

A third preferred embodiment of the information processing system according to the current invention includes the substantially identical components of the first and second preferred embodiments. For the substantially identical components, the same reference numbers are used, and the corresponding description is minimized. In general, the code symbol 3 encodes the coordinate information on the recording medium 1 and the equivalent information. A scanner reads the code symbol 3, and the scanned image is image-processed to decode the information. Since the code symbol 3 is not standardized, the code symbol 3 is not universally interchangeable among the devices. Because of the interchangeability, the third preferred embodiment enables to identify a predetermined group of code symbols 3 by mapping the information from one group to another.

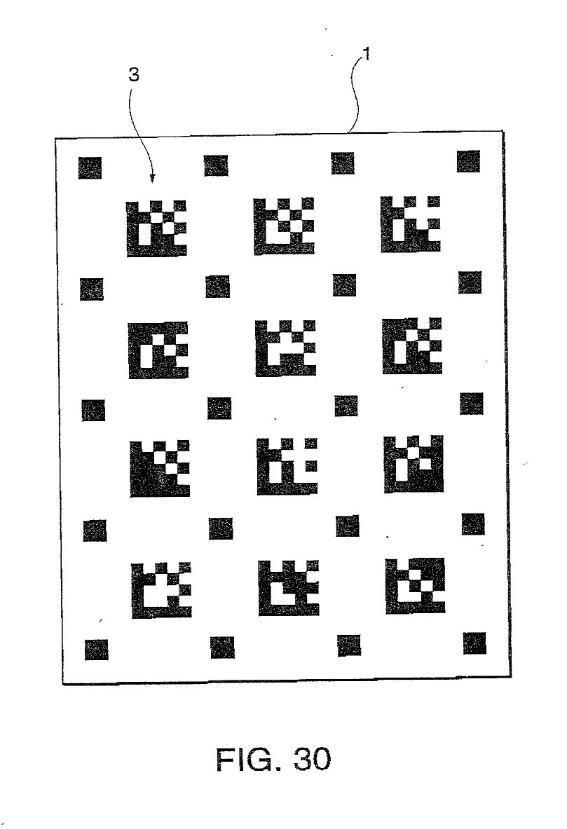

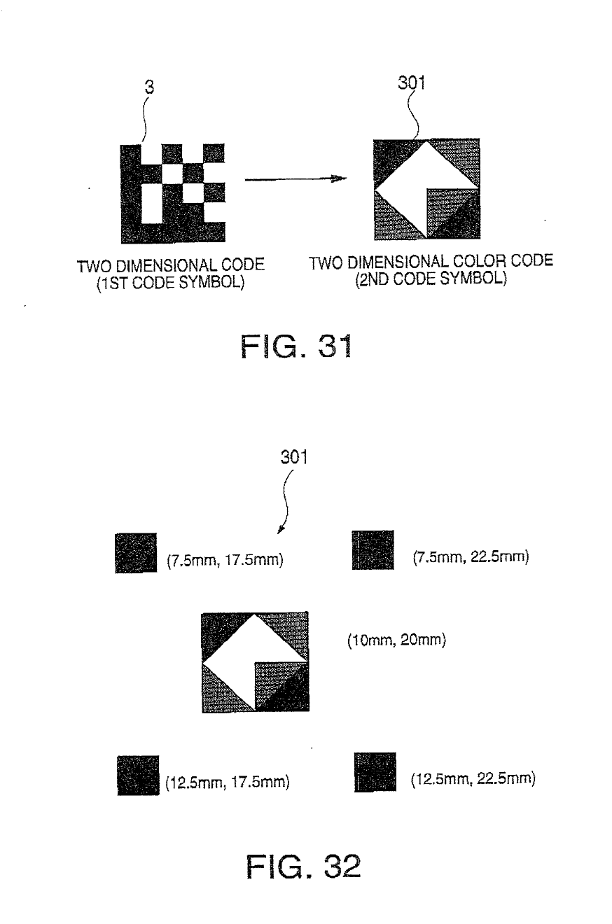

Now referring to FIG. 29, a diagram illustrates a partial image from the recording medium 1 that is read by the image-reading unit 6 to show another exemplary detection of the coordinates on the recording medium 1. On the recording medium 1, the code symbol 3 encodes the coordinate information and the document information in a two-dimensional code as already described with respect to the first and second preferred embodiments. The information processing unit 9, the printer 221 or the copier 241 reads the coordinate and equivalent information based upon the code symbols 3 on the recording medium 1 according to the method described with respect to the second preferred embodiment. The information processing unit 9 converts the coordinate and equivalent information of a first coding group to a second coding group according to the conversion or mapping protocol and prints the converted information via the printer 10. FIG. 29 shows an exemplary code symbol 3 that is assumed to have encoded “0102” and be read from the code symbol 3, which is located at the upper left corner of the recording medium 1 as shown in FIG. 30. The information processing unit 9 converts the code symbol 3 into a corresponding code symbol 301 of another code group as shown in FIG. 31.

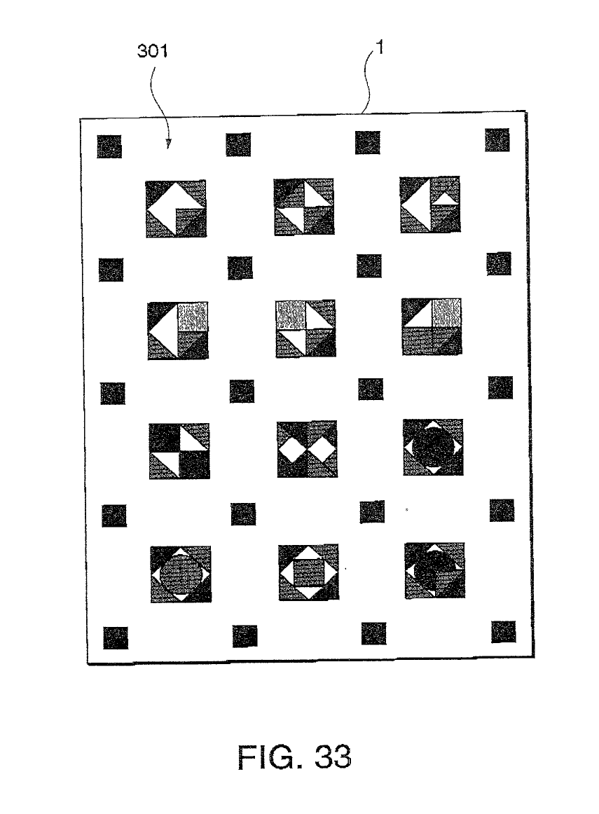

The information processing unit 9 further initiates a print command to the printer 10 to print the “0102” code on the recording medium 1 at 10 mm, 20 mm from the upper left corner. For example, if the size of the code symbol 301 is 5 mm, the coordinates of the code symbol 301 are 7.5 mm, 17.5 mm; 7.5 mm, 22.5 mm; 12.5 mm, 17.5 mm; and 12.5 mm, 22.5 mm as indicated in FIG. 32. FIG. 33 illustrates the converted code symbol 301. This concludes the data conversion from the code symbol 3 to the second code symbol 301 and the printing process.

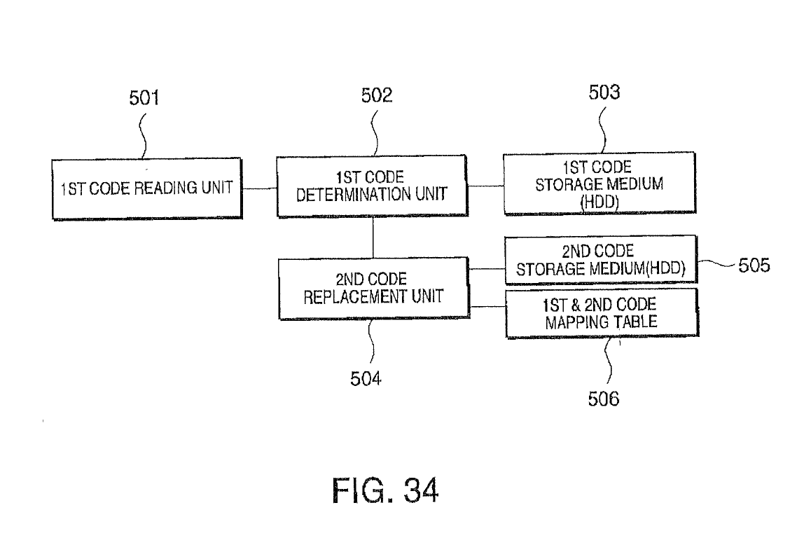

FIG. 34 is a block diagram illustrating one preferred embodiment of the information processing unit 9, the printer 221 or the copier 241 according to the current invention. The functions are identified by grouping various processing tasks that are performed by a certain software program in the microcomputer. The software program is stored in a memory medium such as a read-only memory (ROM), and a microprocessor executes certain tasks according to the software program. One preferred embodiment of the information processing unit 9, the printer 221 or the copier 241 include a first code reading unit 501 such as a scanner for reading a first or original code symbol 3. A first code determination unit 502 determines the coordinates based upon the scanned image of the code symbol 3. To obtain the coordinate information, the first code determination unit 502 obtains information stored in a hard disk drive (HDD) of a first code storage medium 503 to identify a type of coordinate information. The first code determination unit 502 sends the decoded coordinate information to a second code replacement unit 504 so that the first code symbol 3 is replaced by the second code symbol 301. To obtain the coordinate information that is expressed by the second code symbol 301, the second code replacement unit 504 reads in the mapping information between the coordinate information and the second code symbol 301 from a hard disk drive (HDD) in a second code storage medium 505. Finally, the second code replacement unit 504 records in a first and second code mapping table 506 information on which first code symbol 3 is replaced by which second code symbol 301. For example, the first and second code mapping table 506 is a memory area in a HDD and stores the above mapping information in a first and second code mapping table 506.

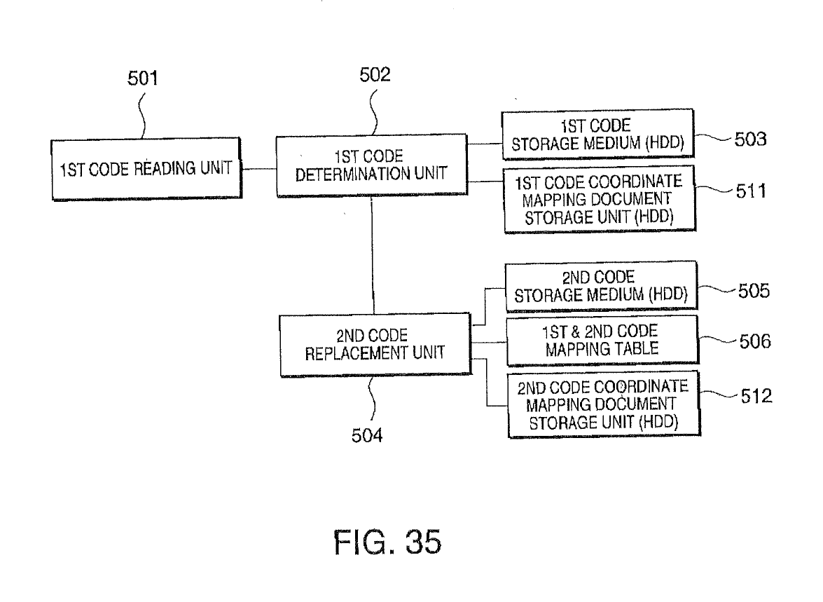

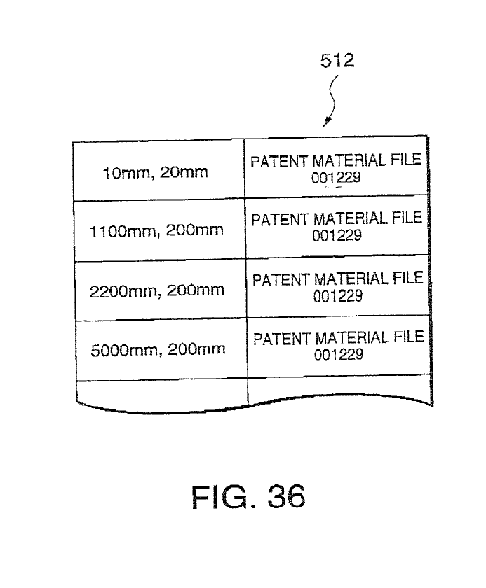

Referring to FIG. 35, a block diagram illustrates an alternative embodiment of the information processing unit 9, the printer 221 or the copier 241 according to the current invention. The functions are identified by grouping various processing tasks that are performed by a certain software program in the microcomputer. The software program is stored in a memory medium such as a read-only memory (ROM), and a microprocessor executes certain tasks according to the software program. A hard disk drive in a first code coordinate mapping document storage unit 511 contains the equivalent information of the first code symbol 3. If the equivalency information corresponds to certain document information, the first code symbol 3 is replaced by the second code symbol 301. The replaced second code symbol 301 then needs to be corresponded to the document information. After the first code determination unit 502 determines the coordinate and equivalent information, the first code determination unit 502 obtains the document information that corresponds to the equivalent information from the first code coordinate mapping document storage unit 511. Having obtained the relationship between the code symbol 3 and the document information, the second code replacement unit 504 stores in a HDD of a second code coordinate mapping document storage unit 512 the mapping relation between the second code symbol 301 and the document information. FIG. 36 shows an exemplary mapping record in the second code coordinate mapping document storage unit 512.

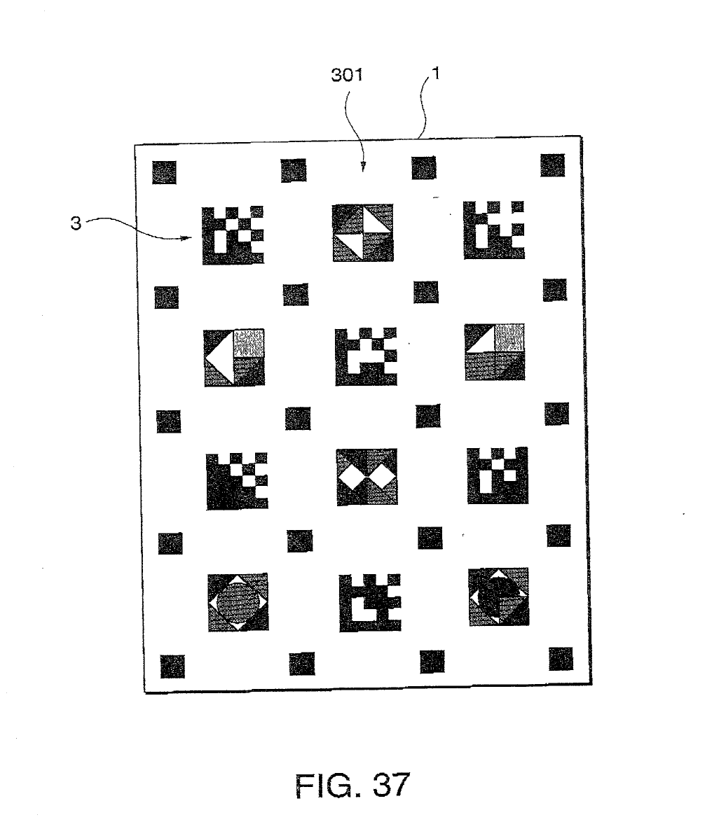

FIG. 37 is a diagram that illustrates first code symbols 3 and second code symbols 301 printed on a recording medium according to the current invention. The first code symbols 3 are printed on the recording medium 1, and the second code symbols 301 are also printed on the same recording medium 1. To print the two kinds of the code symbols 3 and 301 on the same recording medium 1, the first code symbols 3 and the second code symbols 301 are alternately placed, and each of the code symbols 3 and 301 is decoded by separate ones of the information processing unit 9 for obtaining the coordinate and equivalent information. In the above arrangement, since the code symbols 3 and 301 are alternate, the density of the code symbols is relatively low. To increase the code symbol density, either of the code symbols 3 and 301 is made invisible and the tow code symbols are superimposed on top of each other.

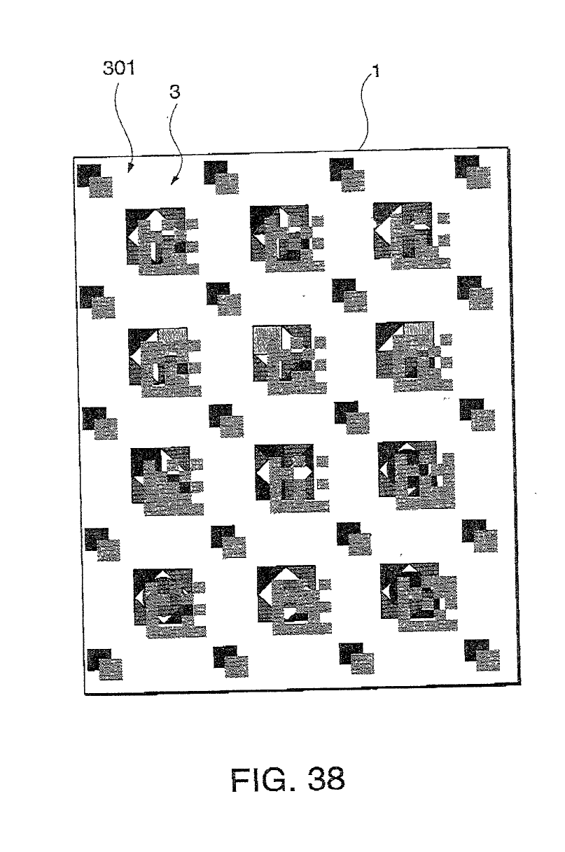

Now referring to FIG. 38, a diagram illustrates that the two types of code symbols are superimposed. The first code symbol 3 is invisible to human eyes and is superimposed on the visible code symbol 301. Although these code symbols 3 and 301 are superimposed, they are independently read. One preferred embodiment of the code symbol according to the current invention illustrates partially overlapping code symbols as shown in FIG. 38. In another preferred embodiment, the two types of the code symbols are completely overlapping. Either embodiment, the two types of the code symbols are independently read. As described above, the information processing unit 9, the printer 221 or the copier 241 processes two types of code symbols on the recording medium 1. A single type of the code symbols limits a number of combined expressions while a combination of at least two types of the code symbols increases the expressions. By the used of increased combinations, an amount of the area on the recording medium 1 is also increased. For example, when two types of the code symbols are printed in a completely superimposed manner, “1234” is obtained from the first code symbol 3 while “5678” is obtained from the second code symbol 301. When either one of the code symbols 3 and 301 is used, the code expression ranges from “0000” to “9999” or has 10000 expressions based upon the decimal numbers. However, when the two code symbols 3 and 301 are combined as in “12345678,” there are 100000000 expressions to specify more areas on the recording medium 1 and improve the precision in reading coordinates.

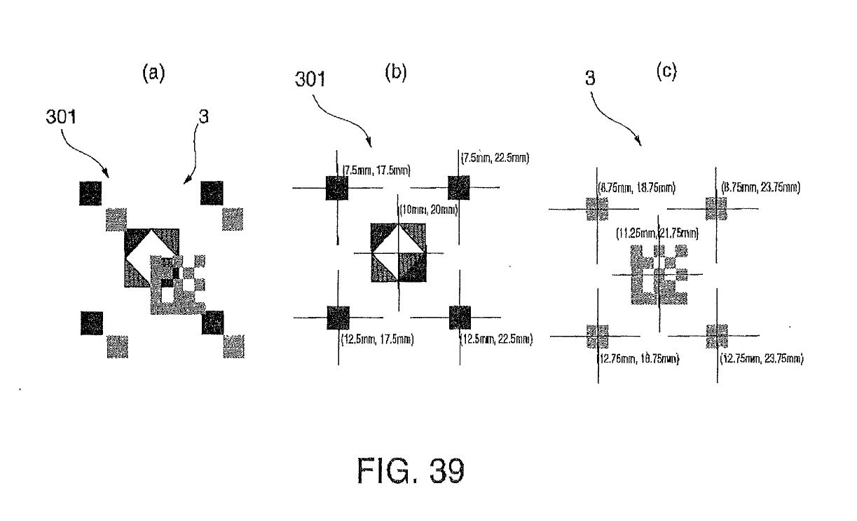

Referring to FIG. 39, diagrams illustrate one preferred method of improving the coordinate reading precision according to the current invention. When the code symbols 3 and 301 are placed to overlap with each other as shown in FIG. 39(a), it is assumed that the center of the code symbol 309 is located at 10 mm and 20 mm respectively in the X and Y directions from the upper left corner of the recording medium 1 as shown in FIG. 39. The distance between the central coordinates and the four corresponding additional symbols is also assumed to be 2.5 mm in both X and Y directions. Under the above assumptions, the resolution of the code symbol 301 is 2.5 mm. In contrast, the code symbol 3 is printed 0.25 mm off from the code symbol 301 in both X and Y directions as shown in FIG. 39(c). In other words, the code symbol 3 is visible through a filter. By the above described method, the code symbols 3 and 301 complement with each other and are read with 1.25 mm distance apart to improve the coordinate reading precision.

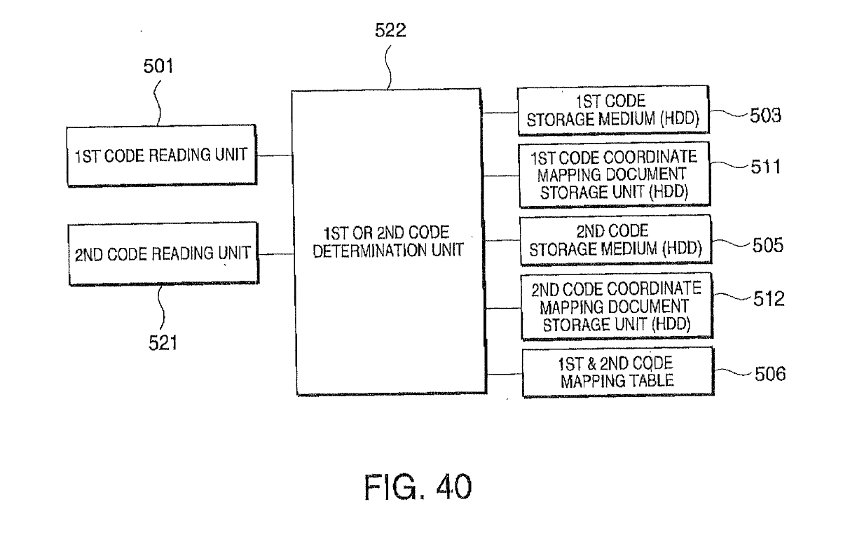

Now referring to FIG. 40, a block diagram illustrates a preferred embodiment of the information processing unit 9, the printer 221 or the copier 241 according to the current invention. The information processing unit 9 includes a first code reading unit 501 and a second code reading unit 521. Either of the first code reading unit 501 and the second code reading unit 521 is equipped with a visible cut filter for invisible code. A first or second code determination unit 522 reads the coordinate information indicated by the code symbol 3 from a first code information record unit 503 or the coordinate information indicated by the code symbol 301 from a second code information record unit 505 based upon the information outputted both from the first code reading unit 501 and the second code reading unit 521. By the above reading mechanism, the coordinate information indicated by the first code symbol 3 and the second code symbol 301 is identified. By obtaining relevant information from a first code coordinate document storage unit 511 and a second code coordinate document storage unit 512, document information that corresponds to the coordinate information of the code symbols 3 and 301 is generated. When corresponding document information is found only in either the first code coordinate document storage unit 511 or the second code coordinate document storage unit 512, the above fact is recorded. For example, if the document information is found only in the first code coordinate document storage unit 511, this fact is recorded in a first and second code corresponding information recording unit 506. The recorded information allows the retrieval of the document information based upon either the first code symbol 3 or the second code symbol 301.

To print the invisible code symbol 3 or 301, a certain type of toner is used. For example, the toner includes dixxx group near-infrared absorbing pigment IRG-022from Nihon Kayaku K. K. On the same sheet of paper, invisible code symbols are printed using the above toner, and visible images are printed using regular visible toner. When the above printed matter is processed with a CCD under a certain predetermined visible cut filter, only the invisible images are identified. In other words, from the code symbols 3 and 301 as shown in FIG. 39(a), only the code symbol 3 is identified as shown in FIG. 39(c). In certain examples, to form an image on the recording medium 1, instead of using conventional infrared absorbing black toner, infrared transmitted toner is available by using yellow toner, magenta toner and cyan toner. Using the yellow, magenta and cyan toner that is infrared non-absorbing, the second code symbol 301 is rendered over the first code symbol 3 that is rendered by the infrared absorbing toner. The two code symbols 3 and 301 are thus superimposed at a low cost. The toner includes terephthalic acid and ethylene oxide added bisphenol A that are polymerized as a resin. The resin is polyester resin that has a molecular weight of Mw=12000, the acid value of five, and a softening point of TM=110° C. The above polyester resin is mixed with coloring agents to form yellow toner, magenta toner and cyan toner. For each color toner, the following exemplary specification is provided:

(1) For producing yellow toner, 95% by weight of the above described polyester resin and 5% by weight of C.I. pigment yellow 95 are fused-mixed by an extruder and subsequently grounded and classified into 50% by weight of toner having an average diameter of 7.0 μm and 50% by weight of fine toner having an average diameter of 4.5 μm.

(2) For producing magenta toner, 95% by weight of the above described polyester resin and 5% by weight of C.I. pigment red 122 are fused-mixed by an extruder and subsequently grounded and classified into 50% by weight of toner having an average diameter of 7.0 μm with <4 μm (pop)=10% and 50% by weight of fine toner having an average diameter of 4.5 μm.

(3) For producing cyan toner, 95% by weight of the above described polyester resin and 5% by weight of C.I. pigment blue 15:3 are fused-mixed by an extruder and subsequently grounded and classified into 50% by weight of toner having an average diameter of 7.0 μm with <4 μm (pop)=10% and 50% by weight of fine toner having an average diameter of 4.5 μm.

(4) For producing black toner, the fine powder that are generated in the above ( 1 ) through (3) is used as follows. 35% by weight of the yellow fine powder, 36 % by weight of the magenta fine powder and 29% by weight of the cyan fine powder are fused-mixed and subsequently grounded and classified into 50% by weight of black toner having an average diameter of 7.0 μm.

The above color toner and the black toner are combined with a ferrite carrier that is covered by styrene methaxxxx copolymer and is utilized in an electrophographic printer such as Ricoh IPSiO Color 5100D. By using the above described toner, an image is formed on the recording medium on which invisible code symbols are formed due to the near infrared absorbing material. Furthermore, when the image is observed using a CCD through the visible cut filter, the visible image is not seen while the invisible image such as the code symbols 3 and 301 is correctly identified.

Another example includes an ink jet method as used in a piezoelectric-type ink jet printer such as Seiko Epson MJ 930. Using ink containing black ink and carbon black and dixxx group near-infrared absorbing pigment IRG-022 from Nihon Kayaku K. K., invisible marks are printed on a sheet of paper, and images including a black image are printed on the paper. Since invisible code symbols are included and an image is formed by color image forming material, a distinct color image is formed. The image is observed through a visible cut filter, the visible image is not seen and only the invisible image is seen for the correct identification of the code symbol 3 and 301.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of managing a document, comprising:
printing the document from an electronic source file on a recording medium with a predetermined set of encoded information at least on coordinates and a file identification of the electronic source file;
editing the document on the recording medium to generate modification;
reading the modification and the encoded information from the recording medium simultaneously with said editing;
decoding the encoded information to generate the coordinates and the file identification; and
updating the electronic source file based upon the file identification, the modification and the coordinates.

2. The method of managing a document according to claim 1 wherein the file identification further includes recording medium identification.

3. The method of managing a document according to claim 2 wherein the recording medium identification and corresponding image source specifying information are stored in a mapping file.

4. The method of managing a document according to claim 3 wherein the mapping file further contains an author name, updated time stamp, a page, a total number of pages and a copy flag.

5. The method of managing a document according to claim 1 wherein the document is prohibited from being printed out if the recording medium identification is not recognized.

6. The method of managing a document according to claim 1 wherein the predetermined set of the encoded information is invisible.

7. The method of managing a document according to claim 1 wherein a first set of the predetermined encoded information is visible and a second set of the predetermined encoded information is invisible.

8. The method of managing a document according to claim 7 wherein the first set of the predetermined encoded information is printed at least partially over the second set of the predetermined encoded information.

9. The method of managing a document according to claim 1 wherein after the predetermined set of the encoded information is decoded to generate decoded information, the decoded information being translated according to another predetermined set of encoded information.

10. The method of managing a document according to claim 1 wherein said decoding further comprises:
determining an amount of distortion of the encoded information that is read in said reading; and
correcting the encoded information based upon the amount of the distortion.

11. The method of managing a document according to claim 1 wherein said reading is continuously being performed.

12. The method of managing a document according to claim 1 wherein the encoded information is printed in a predetermined pattern of two-dimensional code symbols.

13. A computer readable medium storing a computer program for managing a document, the computer program causing a computer and an associated peripheral device to perform the following tasks:
printing the document from an electronic source file on a recording medium with a predetermined set of encoded information at least on coordinates and a file identification of the electronic source file;
editing the document on the recording medium to generate modification;
reading the modification and the encoded information from the recording medium simultaneously with said editing;
decoding the encoded information to generate the coordinates and the file identification; and
updating the electronic source file based upon the file identification, the modification and the coordinates.

14. The computer readable medium according to claim 13 wherein the file identification further includes recording medium identification.

15. The computer readable medium according to claim 14 wherein the recording medium identification and corresponding image source specifying information are stored in a mapping file.

16. The computer readable medium according to claim 15 wherein the mapping file further contains an author name, updated time stamp, a page, a total number of pages and a copy flag.

17. The computer readable medium according to claim 13 wherein the document is prohibited from being printed out if the recording medium identification is not recognized.

18. The computer readable medium according to claim 13 wherein the predetermined set of the encoded information is invisible.

19. The computer readable medium according to claim 13 wherein a first set of the predetermined encoded information is visible and a second set of the predetermined encoded information is invisible.

20. The computer readable medium according to claim 19 wherein the first set of the predetermined encoded information is printed at least partially over the second set of the predetermined encoded information.

21. The computer readable medium according to claim 13 wherein after the predetermined set of the encoded information is decoded to generate decoded information, the decoded information being translated according to another predetermined set of encoded information.

22. The computer readable medium according to claim 13 wherein said decoding further comprises:
determining an amount of distortion of the encoded information that is read in said reading; and
correcting the encoded information based upon the amount of the distortion.

23. The computer readable medium according to claim 13 wherein said reading is continuously being performed.

24. The computer readable medium according to claim 13 wherein the encoded information is printed in a predetermined pattern of two-dimensional code symbols.

25. A system for managing a document, comprising:
a storage unit for storing an electronic source file containing the document;
a printer connected to said storage unit for printing the document from the electronic source file on a recording medium with a predetermined set of encoded information at least on coordinates and a file identification of the electronic source file;
a writing instrument for editing the document on the recording medium to generate modification, said writing instrument including a reading unit for simultaneously reading the modification and the encoded information from the recording medium while editing the document; and
an information processing unit operationally connected to said writing instrument and said storage unit for decoding the encoded information to generate the coordinates and the file identification, said information processing unit updating the electronic source file based upon the file identification, the modification and the coordinates.

26. The system for managing a document according to claim 25 wherein the file identification further includes recording medium identification.

27. The system for managing a document according to claim 26 further comprising a mapping file for storing the recording medium identification and corresponding image source specifying information.

28. The system for managing a document according to claim 27 wherein said mapping file further contains an author name, updated time stamp, a page, a total number of pages and a copy flag.

29. The system for managing a document according to claim 25 wherein said printer is prohibited from printing out the document if said information processing unit fails to recognize the recording medium identification.

30. The system for managing a document according to claim 25 wherein the predetermined set of the encoded information is invisible.

31. The system for managing a document according to claim 25 wherein a first set of the predetermined encoded information is visible and a second set of the predetermined encoded information is invisible.

32. The system for managing a document according to claim 31 wherein the first set of the predetermined encoded information is printed at least partially over the second set of the predetermined encoded information.

33. The system for managing a document according to claim 25 wherein after said information processing unit decodes the predetermined set of the encoded information to generate decoded information, said information processing unit further processes to translate the decoded information according to another predetermined set of encoded information.

34. The system for managing a document according to claim 25 wherein said information processing unit further comprises:
a distortion detection unit for determining an amount of distortion of the encoded information that said reading unit has read; and
a distortion correction unit connected to said distortion detection unit for correcting the encoded information based upon the amount of the distortion.

35. The system for managing a document according to claim 25 wherein said reading unit continuously reads the modification and the encoded information.

36. The system for managing a document according to claim 25 wherein said printer prints the encoded information in a predetermined pattern of two-dimensional code symbols.

37. A recording medium to be used in a document management system, comprising:
a recording area for printing the document in a visible form, said recording area being further recording additional information; and
a predetermined set of encoded information at least on coordinates and a file identification of the electronic source file, said encoded information being subsequently decoded to determine the coordinates on said recording area and the electronic source file, the additional information being combined with the coordinates and the file identification for use in updating the electronic source file according to the additional information.

38. The recording medium according to claim 37 wherein the predetermined set of the encoded information is invisible.

39. The recording medium according to claim 37 wherein a first set of the predetermined encoded information is visible and a second set of the predetermined encoded information is invisible.

40. The recording medium according to claim 39 wherein the first set of the predetermined encoded information is printed at least partially over the second set of the predetermined encoded information.
